(19) United States
(12) Patent Application Publication
(10) Pub. No.: US 2023/0034544 A1
(43) Pub. Date: Feb. 2, 2023

(54) CLOSURE LATCH ASSEMBLY WITH SINGLE MOTOR MULTI-FUNCTIONAL POWER ACTUATOR

(71) Applicant: MAGNA CLOSURES INC., Newmarket (CA)

(72) Inventor: Ann-Margaret MOZOLA, Lakefield (CA)

(21) Appl. No.: 17/868,289

(22) Filed: Jul. 19, 2022

Related U.S. Application Data
(60) Provisional application No. 63/226,167, filed on Jul. 27, 2021.
(60) Provisional application No. 63/270,946, filed on Oct. 22, 2021.

(51) Int. Cl. E05B 77/02; E05B 81/06; E05B 81/14; E05B 85/26; E05B 77/34

(52) U.S. Cl. CPC E05B 77/02; E05B 81/06; E05B 81/14; E05B 85/26; E05B 77/34; E05B 85/243

(57) ABSTRACT

A power latch assembly for a vehicle door of a motor vehicle includes a ratchet configured for movement between striker capture and striker release positions, wherein the ratchet is biased toward the striker release position, and a pawl configured for movement between a ratchet holding position, whereat the pawl maintains the ratchet in the striker capture position, and a ratchet releasing position, whereat the pawl releases the ratchet to the striker release position. A powered actuator is energizable to move the pawl from the ratchet holding position to the ratchet releasing position, and a multistage mechanism operably connecting an output of the power actuator to at least one of the pawl and the ratchet has at least two power takeoffs, with each power takeoff being configured to apply a different torque output to at least one of the pawl and/or the ratchet.

### CROSS-REFERENCE TO RELATED APPLICATION

This application claims the benefit of U.S. Provisional Application Ser. No. 63/270,946, filed Oct. 22, 2021, and U.S. Provisional Application Ser. No. 63/226,167, filed Jul. 27, 2021, which are both incorporated herein by way of reference in their entirety.

### FIELD

The present disclosure relates generally to automotive door latches, and more particularly, to a power door latch assembly equipped with a power release motor driving a multistage gear reduction to provide a normal output force and an increased output force of the power release motor.

### BACKGROUND

This section provides background information related to automotive door latches and is not necessarily prior art to the concepts associated with the present disclosure.

A vehicle closure panel, such as a side door for a vehicle passenger compartment, is hinged to swing between open and closed positions and includes a latch assembly mounted to the door. The latch assembly functions in a well-known manner to latch the door when it is closed and unlatch and release the door to permit subsequent movement of the door to its open position. As is also well known, the latch assembly is configured to include a latch mechanism for latching the door and a release mechanism for unlatching the door. The release mechanism can be power-operated to unlatch the door.

During powered actuation of latch mechanism, it is known to actuate a gear mechanism to move a pawl from a ratchet holding position to a ratchet releasing position, thereby allowing a ratchet to move from a striker capture position to a striker releasing position, whereat the door can be moved from a closed position to an open position. In order to ensure the pawl is able to be moved from the ratchet holding position to the ratchet releasing position, the motor must be provided having a sufficient output force to overcome any friction build-up between the pawl and the ratchet. In some cases, high seal loads are present between the door and the vehicle body, such as in an accident scenario, for example. In other cases, ice may increase the release force needed to move the pawl to the ratchet releasing position. As such, it is known to incorporate a motor having an output force well in excess of that needed during normal use so as to be able to ensure the door can be opened in an increased seal load and/or ice build-up condition. The need to provide the motor having an increased output force well in excess of that needed during normal use, although generally suitable for its intended use, comes with an increased cost, increased size, and increased weight.

Additionally, it is known to provide a secondary motor in addition to the motor used to move a pawl from a ratchet holding position to a ratchet releasing position, such as secondary motors come at an increased cost, while also increasing the size of the closure latch assembly.

Thus, there remains a need to develop alternative arrangements for latch mechanisms for use in vehicular door latches which optimize the ability to move a pawl from a ratchet holding position to a ratchet releasing position, while also providing a cinching function to a ratchet, under the power of a powered motor without having to provide the powered motor having a size in excess of that needed during normal use conditions, and without having to provide multiple motors to accomplish the desired functions.

### SUMMARY

This section provides a general summary of the disclosure, and is not intended to be a comprehensive and exhaustive listing of all of its features or its full scope.

It is an object of the present disclosure to provide a power latch assembly for motor vehicle closure applications that overcomes at least those drawbacks discussed above associated with known power latch assemblies.

It is another object of the present disclosure to provide a power latch assembly for motor vehicle closure applications that has a motor that is optimized in size and output force.

It is another object of the present disclosure to provide a power latch assembly for motor vehicle closure applications that has a motor capable of moving a pawl from a ratchet holding position to a ratchet releasing position under a high seal load condition, including a seal load condition produced during an accident condition, with the motor being minimized in size and output force.

In accordance with the above objects, one aspect of the disclosure provides a power latch assembly for a vehicle door of a motor vehicle including a ratchet configured for movement between striker capture and striker release positions and being biased toward the striker release position. The power latch assembly includes a pawl configured for movement between a ratchet holding position whereat the pawl maintains the ratchet in the striker capture position and a ratchet releasing position whereat the pawl releases the ratchet to the striker release position. A powered actuator is energizable to move the pawl from the ratchet holding position to the ratchet releasing position, wherein a multistage reduction mechanism operably connects an output of the powered actuator to the pawl.

In accordance with another aspect of the disclosure, the multistage reduction mechanism has at least two power takeoffs, with each power takeoff being configured to apply a different torque output to the pawl.

In accordance with another aspect of the disclosure, one of the power takeoffs can be configured to drive a closure panel presenter function.

According to another aspect of the present disclosure, one of the power takeoffs is provided by a first gear reduction and another of the power takeoffs is provided by a second gear reduction, wherein the first and second gear reductions are different from one another.

According to another aspect of the present disclosure, one of the power takeoffs is actuated by rotating the output of the power actuator in a first direction and the other of the power takeoffs is actuated by rotating the output of the power actuator in a second direction opposite the first direction.

According to another aspect of the present disclosure, the first gear reduction is employed by rotating an output of the power actuator in a first direction and the second gear reduction is employed by rotating the output of the power actuator in a second direction opposite the first direction.

According to another aspect of the present disclosure, a first power takeoff is utilized during normal use conditions of the motor vehicle and a second power takeoff is utilized during an increased seal load condition, such as in an accident condition of the motor vehicle, wherein the second power takeoff produces a higher output force on the pawl compared to the first power takeoff.

According to another aspect of the present disclosure, a transition between actuation of the first power takeoff and actuation of the second power takeoff can be signaled via a control unit configured in operable communication with a sensor, wherein the sensor is configured to detect an increased seal load condition.

According to another aspect of the present disclosure, the sensor can be configured to signal the control unit upon detecting an accident condition.

According to another aspect of the present disclosure, the sensor can be configured to detect when load between the pawl and the ratchet has been increased from a normal use load, wherein the sensor is configured in operable communication with the power release actuator, such as via ECU, to automatically reverse the direction of movement of the power release actuator after, thereby increasing the output force on the pawl to overcome the increased load between the pawl and the ratchet to move the pawl to the ratchet releasing position.

According to another aspect of the present disclosure, the first gear reduction includes a first number of gears and the second gear reduction includes a second number of gears, wherein the first number of gears is less than the second number of gears.

According to another aspect of the present disclosure, the first gear reduction includes a first stage gear having a first driven gear configured in meshed engagement with the output of the power release actuator and a first pinion gear fixed to the first driven gear, and a second stage gear having a second driven gear configured in meshed engagement with the first pinion gear.

According to another aspect of the present disclosure, the first pinion gear is coaxial with a rotational axis of the first driven gear.

According to another aspect of the present disclosure, a first drive member can be fixed to the second driven gear, with the first drive member being configured in operable driving communication with the pawl to move the pawl from the ratchet holding position to the ratchet releasing position.

According to another aspect of the present disclosure, a pawl release link can be coupled to the pawl and biased into engagement with the first drive member, with the pawl release link being configured to move the pawl from the ratchet holding position to the ratchet releasing position in response to movement of the second driven gear in a first direction and to return the pawl to the ratchet holding position in response to movement of the second driven gear in a second direction opposite the first direction.

According to another aspect of the present disclosure, the pawl release link can be provided having a slot and a pin extending from the pawl can be received in the slot for lost motion movement of the pin in the slot.

According to another aspect of the present disclosure, the second gear reduction includes the first driven gear configured in meshed engagement with the output of the power release actuator and the second driven gear configured in meshed engagement with the first pinion gear, and further includes a second pinion gear fixed to the second driven gear and a third driven gear configured in meshed engagement with the second pinion gear.

According to another aspect of the present disclosure, the second pinion gear is coaxial with a rotational axis of the second driven gear.

According to another aspect of the present disclosure, a second drive member is fixed to the third driven gear, the second drive member being configured in operable driving communication with the pawl to move the pawl from the ratchet holding position to the ratchet releasing position.

According to another aspect of the present disclosure, the second drive member is configured for direct engagement with the pawl.

According to another aspect of the present disclosure, the first drive member extends from a first side of the second driven gear and the second pinion extends from a second side of the second driven gear opposite the first side.

According to another aspect of the present disclosure, the first gear reduction causes the pawl to move from the ratchet holding position to the ratchet releasing position in X seconds upon actuating the power actuator in the first direction and the second gear reduction causes the pawl to move from the ratchet holding position to the ratchet releasing position in X+Y seconds upon actuating the power actuator in the second direction, wherein X seconds is less that X+Y seconds.

According to another aspect of the present disclosure, a method of increasing the output torque of a latch power release actuator of a power latch assembly from a first output torque to an increased second output torque is provided. The method includes configuring the power release actuator to rotate an output in a first direction to drive a first power takeoff in a first direction to generate the first output torque, and configuring the power release actuator to rotate the output in a second direction to drive a second power takeoff in a second direction opposite the first direction to generate the second output torque.

According to another aspect of the present disclosure, the method further includes configuring the first power takeoff having a first gear reduction and configuring the second power takeoff having a second gear reduction.

According to another aspect of the present disclosure, the method can further include providing the first gear reduction having a first driven gear configured in meshed engagement with the output of the power release actuator and a first pinion gear fixed to the first driven gear, and a second driven gear configured in meshed engagement with the first pinion gear.

According to another aspect of the present disclosure, the method can further include configuring the second gear reduction having the first driven gear arranged in meshed engagement with the output of the power release actuator and the second driven gear arranged in meshed engagement with the first pinion gear, and a second pinion gear fixed to the second driven gear and a third driven gear arranged in meshed engagement with the second pinion gear.

According to another aspect of the present disclosure, the method can further include configuring the second driven gear for operable driving engagement with a pawl of the power latch assembly to move the pawl from a ratchet holding position to a ratchet releasing position upon movement of the first power takeoff in the first direction, and configuring the third driven gear for operable driving engagement with the pawl of the power latch assembly to move the pawl from the ratchet holding position to the ratchet releasing position upon movement of the second power takeoff in the second direction.

According to another aspect of the present disclosure, the method can further include configuring the second driven gear in operable driving engagement with a pawl via a pawl release link and configuring the pawl release link to move the pawl from a ratchet holding position to a ratchet releasing position upon movement of the first power takeoff in the first direction.

According to another aspect of the present disclosure, the method can further include configuring the pawl to move in a lost-motion connection with the pawl release link upon movement of the second power takeoff in the second direction.

According to another aspect of the present disclosure, the method can further include configuring an electronic control unit (ECU) in operable communication with the power release actuator and configuring the ECU to signal the power release actuator to change the direction of rotation of the output of the power release actuator from the first direction to the second direction when increased torque is needed to move the pawl from the ratchet holding position to the ratchet releasing direction.

According to another aspect of the present disclosure, the method can further include configuring the power release actuator to change the direction of rotation of the output of the power release actuator from the first direction to the second direction automatically when the torque applied to the pawl while the output of the power release actuator is moving in the first direction is insufficient to move the pawl from the ratchet holding position to the ratchet releasing direction.

According to another aspect of the present disclosure, a method of releasing a power latch assembly of a closure panel of a motor vehicle is provided. The method includes: detecting a command to power release the power latch assembly; operating a motor of the power latch assembly in a first mode; detecting whether the power latch assembly has been released; stopping the motor if the detecting indicates the power latch assembly has been released; operating the motor of the power latch assembly in a second mode if the detecting indicates the power latch assembly has not been released; detecting whether the power latch assembly has been released; and stopping the motor if the detecting indicates the power latch assembly has been released.

According to another aspect of the present disclosure, the method can further include providing the first mode to include rotating an output of the motor in a first direction and providing the second mode to include rotating an output of the motor in a second direction opposite the first direction.

According to another aspect of the present disclosure, a power latch assembly for a closure panel comprises: a ratchet configured for movement between a striker capture position and a striker release position and being biased toward the striker release position; a pawl configured for movement between a ratchet holding position, whereat the pawl maintains the ratchet in the striker capture position, and a ratchet releasing position, whereat the pawl releases the ratchet for movement of the ratchet to the striker release position; a power release actuator configured to move the pawl from the ratchet holding position to the ratchet releasing position; and a multistage mechanism operably connecting an output of the power release actuator to at least one of the pawl and the ratchet, the multistage mechanism having at least two power takeoffs, with each power takeoff being configured to apply a different torque output to at least the pawl and/or the ratchet.

According to another aspect of the present disclosure, the power release actuator is configured to rotate an output in a first direction to apply a first torque to the pawl to cause the pawl to move from the ratchet holding position to the ratchet releasing position and to rotate the output in a second direction to apply a second torque to the ratchet to cinch the ratchet toward the striker capture position, wherein the second torque is greater than the first torque.

According to another aspect of the present disclosure, the output drives a first driven gear to apply the first torque to the pawl and drives a second driven gear to apply the second torque to the ratchet.

According to another aspect of the present disclosure, a pawl release link can operatively connect the first driven gear to the pawl and a cinch link can operatively connect the second driven gear to the ratchet.

According to another aspect of the present disclosure, the pawl release link can directly connect the first driven gear to the pawl and the cinch link can directly connect the second driven gear to the ratchet.

According to another aspect of the present disclosure, a pinion gear can be operably coupled to the first driven gear, with the pinion gear being in meshed engagement with the second driven gear.

According to another aspect of the present disclosure, the pinion gear can remain substantially stationary when the output is driven in the first direction and can be rotatably driven when the output is driven in the second direction.

According to another aspect of the present disclosure, the second driven gear can remain substantially stationary when the output is driven in the first direction and can be rotatably driven when the output is driven in the second direction.

According to another aspect of the present disclosure, the power release actuator is configured to rotate a first driven member from a home position in a first direction to apply a first torque to the pawl to cause the pawl to move from the ratchet holding position to the ratchet releasing position and to apply a second torque to the ratchet after applying the first torque to the pawl, wherein the second torque is greater than the first torque.

According to another aspect of the present disclosure, the first torque is generated by a first gear train and the second torque is generated by a second gear train.

According to another aspect of the present disclosure, the first gear train is provided by a drive gear couple to an output of the power release actuator and the first driven gear, wherein the drive gear is configured to drive the first driven gear in the first direction to generate the first torque, and the second gear train is provided by a pinion gear fixed to the first driven member and a second driven gear, wherein the pinion gear is configured to drive second driven gear as the first driven gear rotates in the first direction.

According to another aspect of the present disclosure, the drive gear is in meshed engagement with the first driven gear and the pinion gear is in meshed engagement with the second driven gear.

According to another aspect of the present disclosure, a first link coupling the second driven gear to the ratchet.

According to another aspect of the present disclosure, the first link is detachably coupled to the second driven gear.

According to another aspect of the present disclosure, a second link operably coupling the first driven gear to the first link.

According to another aspect of the present disclosure, a central hub assembly coupled to the first driven gear for lost-motion with the first driven gear, with the second link being coupled to the central hub assembly.

According to another aspect of the present disclosure, the central hub assembly is configured to remain substantially stationary when the first driven member rotates in the first direction.

According to another aspect of the present disclosure, the central hub assembly includes a central lever coupled to a crash unlock lever, wherein the central lever and the crash unlock lever are configured for lost-motion with one another.

According to another aspect of the present disclosure, the second link is coupled to the crash unlock lever.

According to another aspect of the present disclosure, the power release actuator is configured to rotate the first driven member in a second direction opposite the first direction toward the home position, whereupon the first link is configured to move the ratchet in a cinching operation to the striker capture position.

According to another aspect of the present disclosure, the power release actuator is configured to rotate the first driven member in the second direction opposite the first direction toward the home position, whereupon the crash unlock lever rotates concurrently with the first driven member causing the second link to decouple the first link from the second driven member and to decouple the power release actuator from the ratchet.

According to another aspect of the present disclosure, the pawl is configured to be manually moved by a manual release lever from the ratchet holding position to the ratchet releasing position while the first link is decoupled from the second driven member and the power release actuator is decoupled from the ratchet.

According to another aspect of the present disclosure, a method of releasing a power latch assembly and cinching the power latch assembly of a closure panel of a motor vehicle is provided. The method comprising: operating a motor of the power latch assembly in a first mode to rotate an output in a first direction to move a pawl from a ratchet holding position to a ratchet releasing position and causing a ratchet to move from a striker capture position to a striker release position until the power latch assembly is released; and operating the motor of the power latch assembly in a second mode to rotate the output in a second direction opposite the first direction to move the ratchet toward the striker capture position until the power latch assembly is cinched.

According to another aspect of the present disclosure, the method can further include detecting whether the power latch assembly has been released and stopping the motor if the detecting indicates the power latch assembly has been released and detecting whether the power latch assembly has been cinched and stopping the motor if the detecting indicates the power latch assembly has been cinched.

According to another aspect of the present disclosure, the method can further include coupling a first driven member to the pawl and coupling a second driven member to the ratchet, and applying a first torque from the first driven member on the pawl upon operating the motor in the first mode and applying a second torque from the second driven member on the ratchet upon operating the motor in the second mode, with the second torque being greater than the first torque.

According to another aspect of the present disclosure, the method can further include coupling the first driven member to the pawl with a pawl release link and coupling the second driven member to the ratchet with a cinch link, and applying a first torque from the first driven member through the pawl release link on the pawl upon operating the motor in the first mode and applying the second torque from the second driven member through the cinch link on the ratchet upon operating the motor in the second mode.

According to another aspect of the present disclosure, the method can further include configuring the first driven member to rotate from a home position in a first direction to apply a first torque to the pawl to cause the pawl to move from the ratchet holding position to the ratchet releasing position and, if the ratchet remains in the striker capture position, to apply a second torque to the ratchet after applying the first torque to the pawl, wherein the second torque is greater than the first torque.

According to another aspect of the present disclosure, a method of releasing a power latch assembly and presenting a closure panel of a motor vehicle is provided. The method comprising: operating a motor of the power latch assembly in a first mode to rotate an output in a first direction to move a pawl from a ratchet holding position to a ratchet releasing position and causing a ratchet to move from a striker capture position to a striker release position until the power latch assembly is released; and operating the motor of the power latch assembly in a second mode to drive a presenter to move the closure panel to at least a partially open position.

According to yet another aspect, a power latch assembly for a closure panel includes a ratchet configured for movement between a striker capture position and a striker release position and being biased toward said striker release position, a pawl configured for movement between a ratchet holding position, whereat said pawl maintains said ratchet in said striker capture position, and a ratchet releasing position, whereat said pawl releases said ratchet for movement of said ratchet to said striker release position, a power actuator having an output, and a multistage mechanism operably connected to the output of the power actuator, the multistage mechanism configured to actuate a primary latch function during a normal operating mode and actuate the secondary latch function during an extended operating mode.

According to yet another aspect, a method of operating a power latch assembly of a closure panel of a motor vehicle includes operating a motor of the power latch assembly in a first normal mode to actuate a multistage mechanism to control a primary latch function and operating the motor of the power latch assembly in an extended mode to actuate a multistage mechanism to control a secondary latch function.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

These and other aspects, features, and advantages of the present disclosure will be readily appreciated, as the same becomes better understood by reference to the following detailed description when considered in connection with the accompanying drawings wherein:

FIG. 1 is a partial perspective view of a motor vehicle having a side door equipped with a power latch assembly embodying the teachings of the present disclosure;

FIG. 2 is a front side view of a power latch assembly embodying the teachings of the present disclosure shown schematically in operable communication with various components of the side door, with some components removed for clarity purposes only;

FIG. 2A is a rear side view of the power latch assembly of FIG. 2 with a latch plate shown in transparency for clarity reasons only;

FIG. 3A is a top perspective view of a power actuator and latch components of the power latch assembly embodying the teachings of the present disclosure with a pawl of the power latch assembly shown in a ratchet holding position with a ratchet of the power latch assembly;

FIG. 3B is a bottom perspective view of the power actuator and latch components of the power latch assembly of FIG. 3A;

FIG. 4A is a side view of the power latch assembly of FIG. 3A shown during an initial stage of a normal release condition with the pawl shown in the ratchet holding position;

FIG. 4B is a fragmentary perspective view of the power latch assembly of FIG. 4A;

FIG. 4C is a view similar to FIG. 4A;

FIG. 5 is a view similar to FIG. 4A with the pawl shown in a ratchet release position during the normal release condition;

FIG. 6 is a view similar to FIG. 5 with the pawl shown returned to the ratchet capture position;

FIG. 7 is a front side view of the power latch assembly of FIG. 3A shown during an initial stage of an emergency release condition with the pawl shown in the ratchet holding position;

FIG. 7A is an enlarged fragmentary back side view of the power latch assembly of FIG. 7;

FIG. 8 is a view similar to FIG. 7 with the pawl shown in a ratchet release position during the emergency release condition;

FIG. 9 is a side view of a power latch assembly in accordance with another aspect of the disclosure shown with a pawl shown in solid in a ratchet holding position and in transparency in a ratchet releasing position;

FIG. 10 is a side plan view of the power latch assembly illustrating the rotation of a multistage reduction mechanism operably connecting an output of the power release actuator to the pawl, with a first gear reduction shown being rotated in a first direction during movement of the pawl from the ratchet holding position to the ratchet releasing position under a normal load between the pawl and the ratchet, and with a second gear reduction shown being rotated in a second direction during movement of the pawl from the ratchet holding position to the ratchet releasing position under an increased load, relative the normal load, between the pawl and the ratchet;

FIG. 11 is a method of moving a pawl from a ratchet holding position to a ratchet releasing position with a power latch assembly having first and second modes of operation in accordance with an aspect of the disclosure;

FIG. 12 is a method of releasing a power latch assembly of a closure panel of a motor vehicle;

FIG. 13 is a method of releasing a power latch assembly of a closure panel of a motor vehicle in accordance with another aspect of the disclosure;

FIG. 14 is a front perspective view of another power latch assembly embodying the teachings of the present disclosure shown in a latched position;

FIG. 15 is a view similar to FIG. 14 with a cover removed for clarity purposes only;

FIG. 16 is a view similar to FIG. 15 showing a direction of movement of a first driven gear during a power release operation of the power latch assembly;

FIG. 17 is a side plan view showing a multistage reduction mechanism of the power latch assembly of FIG. 14 while in a home position;

FIG. 18 is a view similar to FIG. 17 showing the first driven gear moved from the home position to a power release position, whereat a pawl moves to a ratchet release position and a ratchet is free to move to a striker release position to bring the power latch assembly to a released position, while a second driven gear remains in a home position;

FIG. 19 is a view similar to FIG. 17 showing the first driven gear and the second driven gear moved from the home position to a cinch position, whereat the ratchet of the power latch assembly moved to a striker cinch position to bring the power latch assembly to a cinched position;

FIG. 20 is a view similar to FIG. 17 showing the first driven gear returned to the home position after being moved to each of the power release position and the cinch position;

FIG. 21 is a flow diagram illustrating a method of releasing a power latch assembly and cinching the power latch assembly of a closure panel of a motor vehicle in accordance with another aspect of the disclosure;

FIG. 22A is a front perspective view of another power latch assembly embodying the teachings of the present disclosure shown in a latched position with various components removed for clarity purposes only;

FIG. 22B is a rear perspective view of the power latch assembly of FIG. 22A;

FIGS. 23A-23C illustrate a sequential build-up of a drive hub assembly of the power latch assembly of FIGS. 22A and 22B;

FIGS. 24A and 24B illustrate front and rear perspective views, respectively, of a central lever of the drive hub assembly of FIGS. 23A-23C;

FIGS. 25A and 25B illustrate front and rear perspective views, respectively, of a crash unlock lever of the drive hub assembly of FIGS. 23A-23C;

FIG. 26 illustrates an auxiliary pawl in accordance with one non-limiting aspect of the disclosure;

FIG. 26A illustrates an auxiliary pawl in accordance with another non-limiting aspect of the disclosure;

FIGS. 27A and 27B illustrate front and rear side views, respectively, of the power latch assembly of FIGS. 22A and 22B while in a latched state;

FIGS. 28A, 28B through 34A, 34B illustrate sequential front and rear side views, respectively, of the power latch assembly of FIGS. 27A and 27B as it moves under power from the latched state of FIGS. 27A and 27B to an unlatched state of FIGS. 34A and 34B;

FIGS. 35A, 35B through 41A, 41B illustrate sequential front and rear side views, respectively, of the power latch assembly of FIGS. 22A and 22B as it moves under power from the unlatched state of FIGS. 34A and 34B to a latched state of FIGS. 41A and 41B;

FIGS. 42A, 42B through 50A, 50B illustrate sequential front and rear side views, respectively, of the power latch assembly of FIGS. 22A and 22B as it moves under power from the latched state of FIGS. 41A and 41B to a crash unlock state and cinch disengaged state of FIGS. 44A and 44B, whereupon an actuator is driven back to a home position in FIGS. 45A, 45B through 46A, 46B, and then under manual operation, as shown in FIGS. 47A, 47B through 50A, 50B, a pawl is moved from a ratchet holding position to a ratchet release position whereupon power latch assembly is moved from the latched state to the unlatched state of FIGS. 50A, 50B;

FIG. 51A is a side view of another power latch assembly operating in a normal mode in accordance with further aspects of the present disclosure;

FIG. 51B is a side view of power latch assembly of FIG. 51A operating in an extended mode in accordance with further aspects of the present disclosure;

FIG. 52A shows the multistage mechanism having a first range of motion for controlling a primary latch function;

FIG. 52B shows the multistage mechanism traveling over the first range of motion controlling the primary latch function;

FIG. 52C shows the multistage mechanism having a second range of motion for controlling an extended latch function; and

FIG. 52D shows the multistage mechanism traveling over the second range of motion controlling the extended latch function.

Corresponding reference numerals are used throughout all of the drawings to indicate corresponding parts.

### DETAILED DESCRIPTION OF EXAMPLE EMBODIMENTS

One or more example embodiments of a powered latch assembly of the type well-suited for use in motor vehicle closure systems will now be described with reference to the accompany drawings. However, these example embodiments are only provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail, as they will be readily understood by a skilled artisan.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on,” “engaged to,” “connected to,” or “coupled to” another element or layer, it may be directly on, engaged, connected or coupled to the other element or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various elements, components, regions, layers and/or sections, these elements, components, regions, layers and/or sections should not be limited by these terms. These terms may be only used to distinguish one element, component, region, layer or section from another region, layer or section. Terms such as “first,” “second,” and other numerical terms when used herein do not imply a sequence or order unless clearly indicated by the context. Thus, a first element, component, region, layer or section discussed below could be termed a second element, component, region, layer or section without departing from the teachings of the example embodiments.

Spatially relative terms, such as “inner,” “outer,” “beneath,” “below,” “lower,” “above,” “upper,” “top”, “bottom”, and the like, may be used herein for ease of description to describe one element's or feature's relationship to another element(s) or feature(s) as illustrated in the figures. Spatially relative terms may be intended to encompass different orientations of the device in use or operation in addition to the orientation depicted in the figures. For example, if the device in the figures is turned over, elements described as “below” or “beneath” other elements or features would then be oriented “above” the other elements or features. Thus, the example term “below” can encompass both an orientation of above and below. The device may be otherwise oriented (rotated degrees or at other orientations) and the spatially relative descriptions used herein interpreted accordingly.

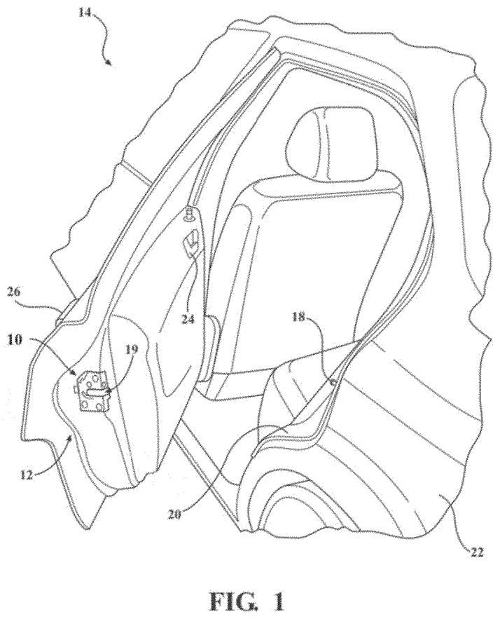

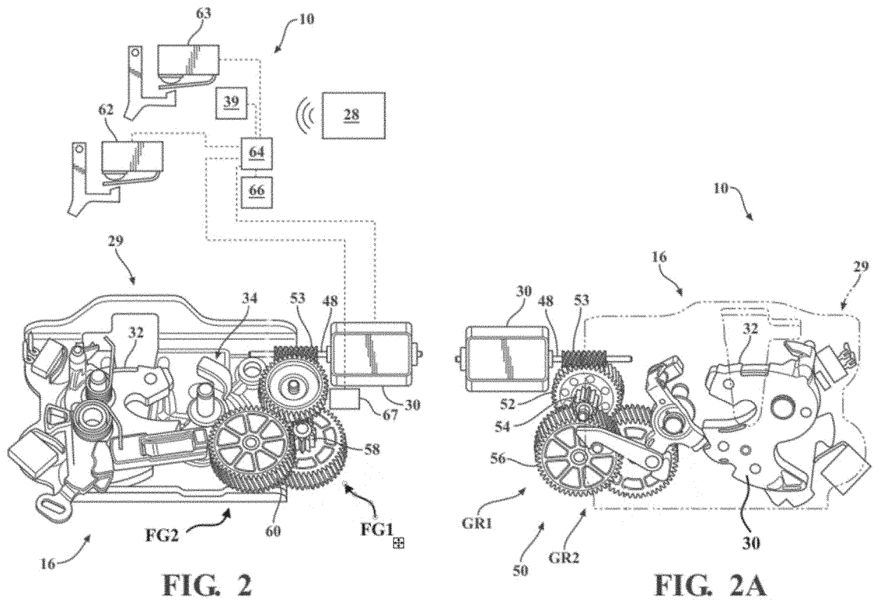

Referring initially to FIG. 1, a non-limiting example of a power latch assembly is shown, referred to hereafter simply as latch assembly 10, installed in a closure panel, such as, by way of example and without limitation, a door, shown as a passenger side swing door 12 of a motor vehicle 14. Latch assembly 10 includes a latch mechanism 16 configured to releasably latch and hold a striker 18 mounted to a sill portion 20 of a vehicle body 22 when swing door 12 is closed. Latch assembly 10 can be selectively actuated via an inside door handle 24, an outside door handle 26, and a key fob 28 (FIG. 2). As will be detailed, latch assembly 10 is configured to be power-operated via selective actuation of a power release actuator, such as an electric motor 30. For reasons discussed hereafter, power release actuator 30 is able to be minimized in size, weight and power output, thereby enhancing the flexibility of design of the closure panel, while also reducing the cost associated therewith. Further yet, as discussed in further detail below, the power release actuator 30 is assured of having sufficient power to move latch mechanism 16 from a latched state to an unlatched state, even if friction forces within latch mechanism are suddenly increased, such as may result in a crash condition, thereby allowing closure panel 12 to be moved from a closed position to an open position.

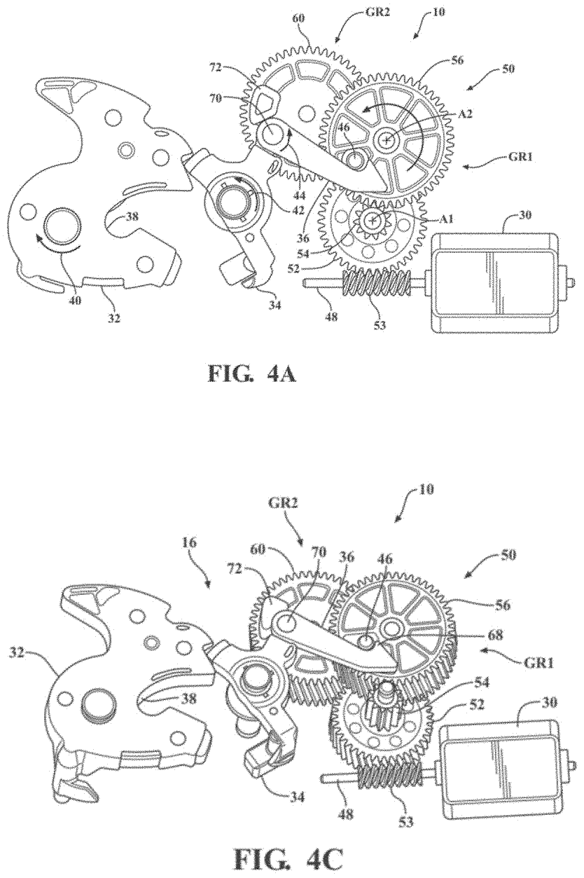

Referring to FIG. 2, shown is a non-limiting embodiment of latch assembly 10 and latch mechanism 16 contained in a housing, shown in part via a latch frame plate 29, with some components removed for clarity purposes. Latch mechanism 16 includes a ratchet 32 and a pawl 34, and a release lever, also referred to as release link, pawl release lever, or pawl release link 36. Ratchet 32 is movable between a striker capture position, whereat ratchet 32 retains striker 18 with a striker slot 38 of ratchet 32 and swing door 12 in closed position, and a striker release position, whereat ratchet 32 permits release of striker 18 from a fishmouth 19 provided by latch housing of latch assembly 10 to allow movement of swing door 12 to the open position. A ratchet biasing member 40 (FIG. 4A), such as a spring, is provided to normally bias ratchet 32 toward its striker release position. Pawl 34 is movable between a ratchet holding position, whereat pawl 34 holds ratchet 32 in its striker capture position, and a ratchet releasing position whereat pawl 34 permits ratchet 32 to move to its striker release position. A pawl biasing member 42, such as a suitable spring, is provided to normally bias pawl 34 toward its ratchet holding position.

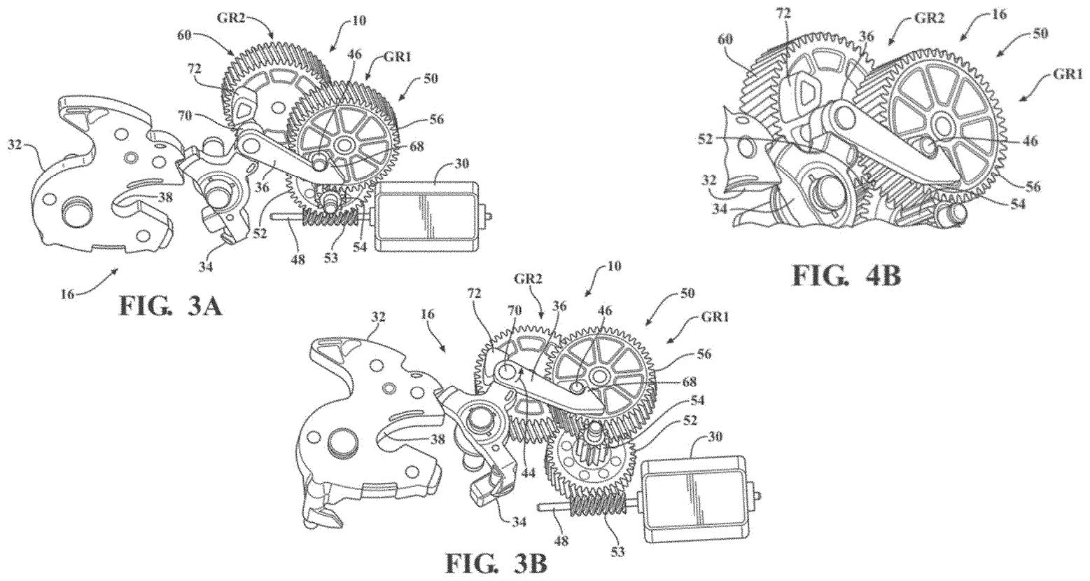

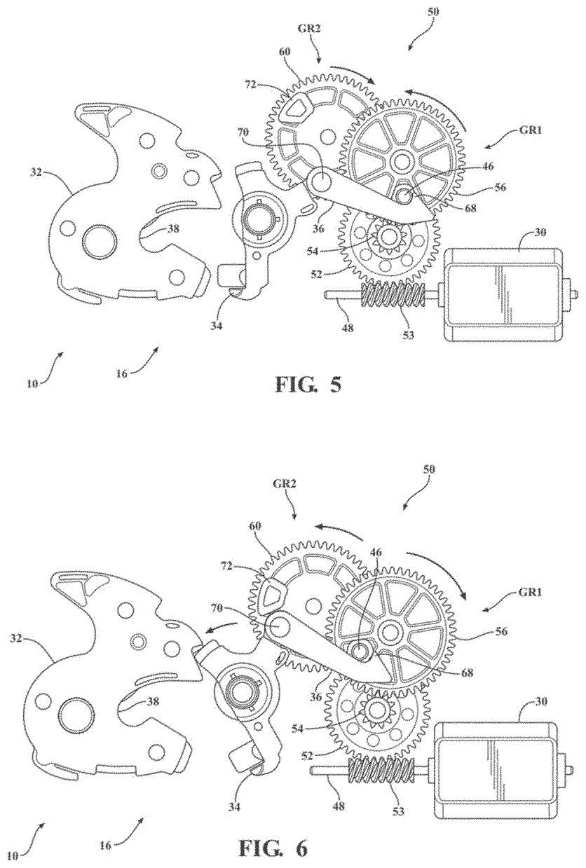

Pawl release link 36 is operatively (directly or indirectly via another component, such as an intermediate or secondary pawl release lever, and shown as directly, by way of example and without limitation) coupled, also referred to as connected, to pawl 34 and is movable between a deployed position, also referred to as pawl release position, whereat pawl release link 36 moves pawl 34 against the bias of pawl biasing member 42 to its ratchet releasing position (FIG. 5), and a non-deployed position, also referred to as home position (FIGS. 3A-4C and 6), whereat pawl release link 36 permits pawl 34 to be in its ratchet holding position. A release link biasing member 44 (FIG. 4A), such as a suitable spring, can be provided to normally bias pawl release link 36 into engagement with a drive member, also referred to as first drive member 46.

Pawl release link 36 can be moved to its pawl release position via selective actuation of power release actuator 30. Power release actuator 30 has an output, shown as being provided by an output member, also referred to as output shaft 48, which is operably connected or coupled to pawl 34 via a multistage reduction mechanism 50. Multistage reduction mechanism 50, when driven by power release actuator 30, is configured to move pawl release link 36 to its pawl release position, whereat pawl 34 is moved to its ratchet releasing position.

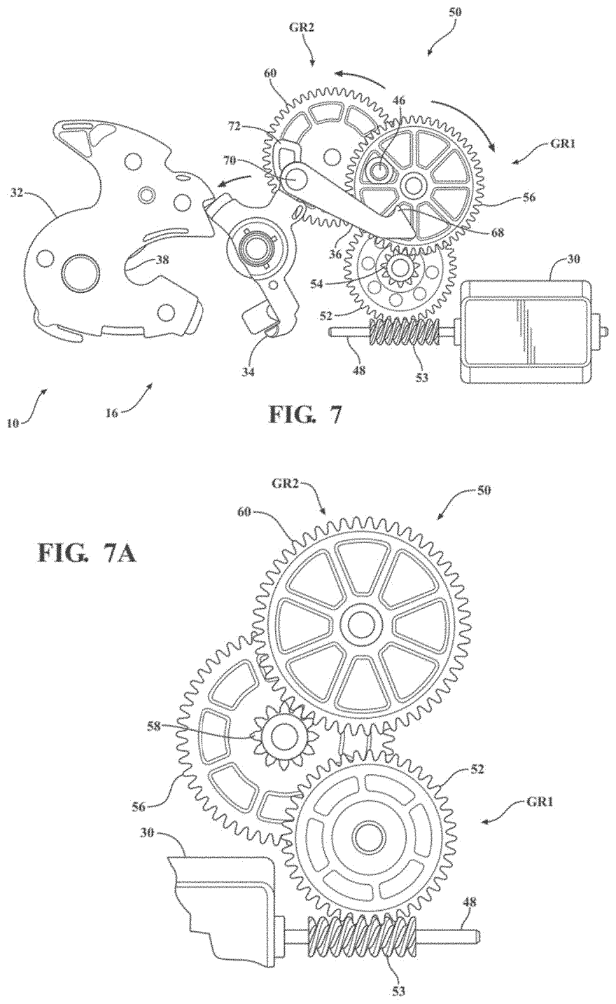

Pawl release link 36, under normal use conditions (pawl 34 and ratchet 32 are configured as manufactured and have retained an “as manufactured” force of friction therebetween), is moved to its pawl release position via a first power takeoff of multistage reduction mechanism 50. First power takeoff is provided by a first gear reduction GR1 including a first number of gears, shown, by way of example and without limitation, as including a first driven gear 52 configured in meshed engagement with an output gear, also referred to a main drive gear or drive gear 53, wherein drive gear 53 is shown as a worm gear mounted on output shaft 48 and fixed for conjoint rotation with the output shaft 48 of power release actuator 30, and a first pinion gear 54 fixed to the first driven gear 52, shown as being fixed concentrically therewith for rotation about a common first axis A1 (FIG. 4A), and a second stage gear having a second driven gear 56 (FIGS. 2 and 7A) configured in meshed engagement with the first pinion gear 54. The first drive member 46 is shown fixed to second driven gear 56 for conjoint movement therewith, with first drive member 46 shown being fixed between an outer periphery and a second axis A2 about which second driven gear 56 rotates.

Pawl 34, under an emergency use condition (pawl 34 and ratchet 32 are have an unusually high, increased amount of friction therebetween as compared to the normal use condition), is moved to its pawl release position via a second power takeoff of multistage reduction mechanism 50, wherein the second power takeoff is different from the first power takeoff. Second power takeoff is provided by a second gear reduction GR2 including a second number of gears, wherein the second number of gears of the second power takeoff is different from the first number of gears of the first power takeoff. The second gear reduction GR2 is shown, by way of example and without limitation, as including the first driven gear 52 configured in meshed engagement with the drive gear 53 and the second driven gear 56 configured in meshed engagement with the first pinion gear 54, and further including a second pinion gear 58 fixed to the second driven gear 56, shown as being fixed concentrically therewith for rotation about the common second axis A2 (FIG. 4A), and a third driven gear 60 configured in meshed engagement with the second pinion gear 58.

When desired to move pawl 34 from the ratchet holding positon to the ratchet releasing position during normal use conditions, such as when a person approaches motor vehicle 14 with electronic key fob 28 (FIG. 2) and actuates the outside door handle 26, for example, sensing both the presence of key fob 28 and that outside door handle 26 has been actuated (e.g. via electronic communication between an electronic switch 62 (FIG. 2, wherein inside door handle 24 also is actuatable via an electronic switch 63) and a latch electronic control unit (ECU) shown at 64 that at least partially controls the operation of latch assembly 10). In turn, latch ECU 64 actuates power release motor 30 to cause the first gear reduction GR1 to become actuated by rotating the output shaft 48 of the power actuator 30 in a first direction to release the latch mechanism 16 and shift latch assembly 10 into an unlatched operating state so as to facilitate subsequent opening of vehicle swing door 12. Power release motor 30 can be alternatively activated as part of a proximity sensor based entry feature (radar based proximity detection for example), for example when a person approaches vehicle 14 with electronic key fob 28 (FIG. 2) and actuates a proximity sensor 66, such as a capacitive sensor, or other touch/touchless based sensor (based on a recognition of the proximity of an object, such as the touch/swipe/hover/gesture or a hand or finger), (e.g. via communication between the proximity sensor 66 and latch ECU 64 that at least partially controls the operation of latch assembly 10). In turn, if detecting a normal use condition, such as the presence of electronic key fob 28, by way of example and without limitation, latch ECU 64 actuates power release motor 30 to rotate the output shaft 48 in the first direction to release the latch mechanism 16 and shift latch assembly 10 into an unlatched operating state so as to facilitate subsequent opening of vehicle door 12, as discussed above.

During normal operation, as output shaft 48 is rotated in the first direction, drive gear 53 causes first driven gear 52 to rotate in a clockwise direction, as viewed in FIG. 4A, whereupon first pinion gear 54 is driven conjointly in the clockwise direction, thereby causing second driven gear 56 to be driven in a normal release counterclockwise direction. As second driven gear 56 rotates in the normal release counterclockwise direction, first drive member 46, fixed to second driven gear 56, comes into engagement with pawl release link 36, shown as confronting and engaging a hook member 68 of pawl release link 66. In accordance with a non-limiting aspect of the disclosure, second driven gear 56 rotates few degrees, such as between about 1-10 degrees, by way of example and without limitation, prior to first drive member 46 coming into engagement with hook member 68. Accordingly, inertia of second driven gear 56 facilitates driving pawl release link 36 from the home position to the pawl release position, whereat pawl release link 36 moves pawl 32 against the bias of pawl biasing member 42 to its ratchet releasing position (FIG. 5), whereat ratchet 32 is free to move to the striker release position under the bias of ratchet biasing member 40.

Then, upon release of power latch assembly 10, ECU 64, upon receiving a signal from a position sensor 67, which can be configured to detect the relative position of ratchet 32 and/or pawl 34, signals power release motor 30 to rotate in an opposite direction, thereby causing a reversal in motion of first gear reduction GR1 to ultimately cause second driven gear 56 to be rotated in a clockwise direction, as viewed in FIG. 6, whereupon pawl release link 36 is allowed to return to its home position, such as under the bias of pawl biasing member 42 returning pawl 34 to the ratchet holding position. Pawl release link 36 is coupled to pawl 34, such as via a pin 70, such that pawl release link moves conjointly with pawl 34 as it is biased by pawl biasing member 42 to the ratchet holding position.

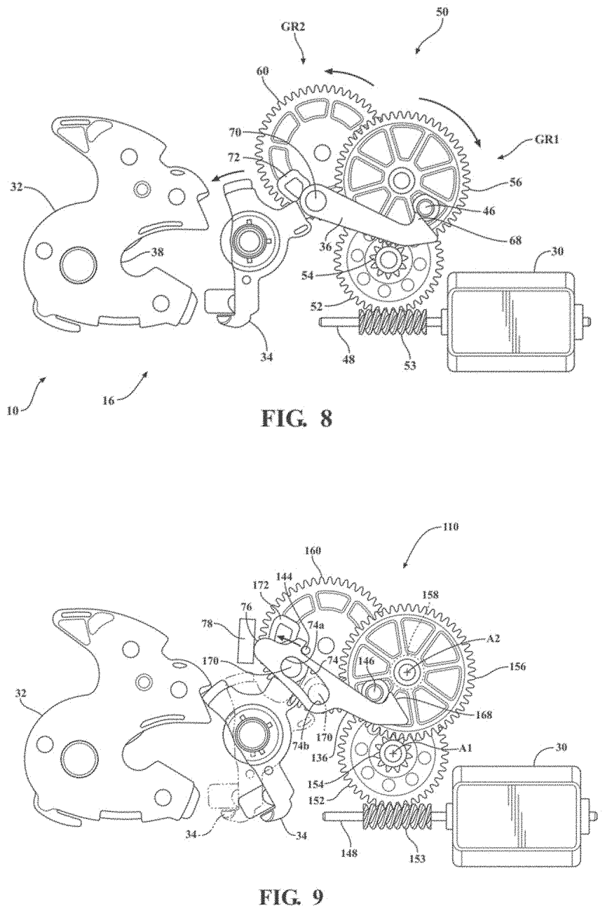

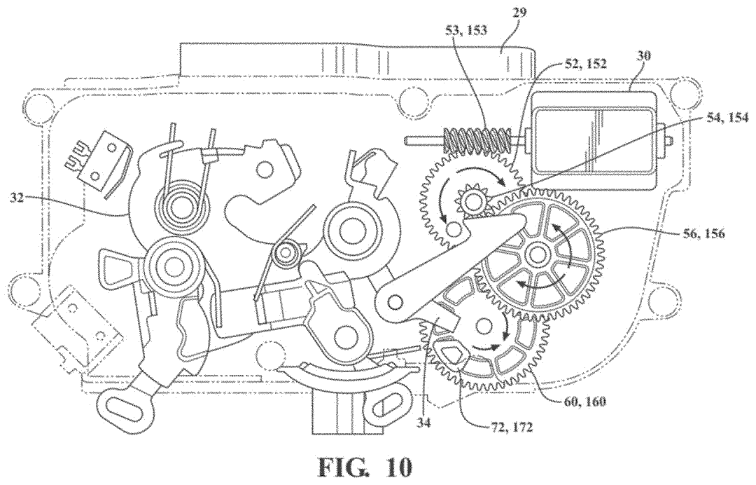

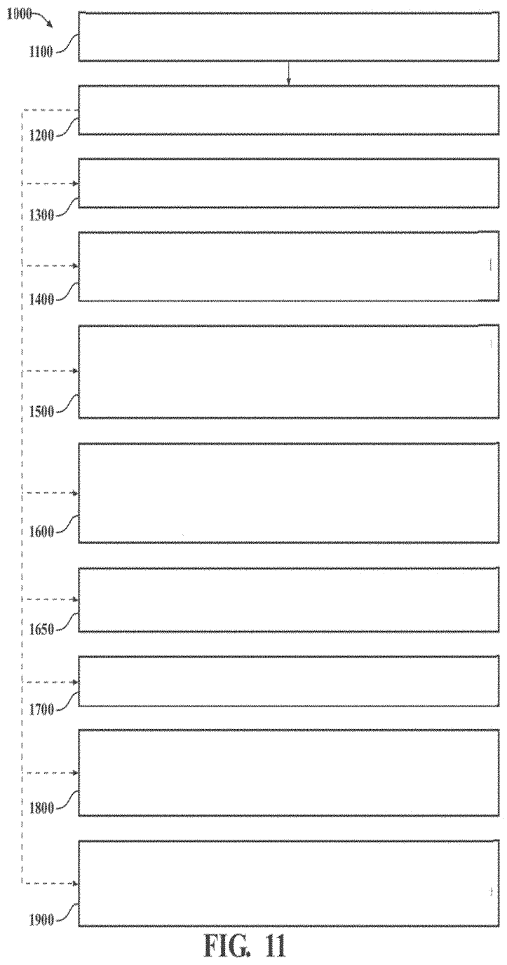

During emergency operation, including any time normal operation fails to cause pawl 34 to be moved from its ratchet holding position to its ratchet releasing position, as can be detected by position sensor 67, ECU signals power release motor 30 to rotate output shaft 48 in the second direction, opposite the first direction of normal operation, thereby activating the second gear reduction GR2. As such, drive gear 53 causes first driven gear 52 to rotate in a counterclockwise direction, as viewed in FIG. 7, whereupon first pinion gear 54 is driven conjointly in the counterclockwise direction, thereby causing second driven gear 56 to be driven in an emergency release clockwise direction. As second driven gear 56 rotates in the emergency release clockwise direction, second pinion gear 58, fixed to second driven gear 56, drives third driven gear 60 in a counterclockwise direction, as viewed in FIG. 8, whereupon a second drive member 72, fixed to the third driven gear 60, is driven into operable driving communication with pawl 34 to move pawl 34 from the ratchet holding position to the ratchet releasing position. In accordance with one non-limiting aspect, second drive member 72 can be configured for direct engagement with pawl 34 or pin 70, thereby directly driving pawl 34 to the ratchet release position (FIG. 8). It will be appreciated by one possessing ordinary skill in the art that the second gear reduction GR2 activated in the emergency use condition imparts a greater torque, referred to as second torque, on pawl 34 in comparison to a first torque produced by the first gear reduction GR1 activated during the normal use condition. The relative differences between the first torque and the second torque can be adjusted as desired via providing the desire number of gear teeth on the gears of first and second gear reductions GR1, GR2. In a non-limiting example, drive gear 53 has 2 teeth and the first driven gear 52 has 40 teeth, resulting in a torque multiplier of 40/2=20; first pinion gear 54 has 11 teeth and second driven gear 56 has 50 teeth, resulting in a torque multiplier of 50/11=4.54, and thus, first gear reduction GR1 produces a total torque multiplier of 20×4.54=90.8 during normal use. In contrast, an additional torque multiplication is provided in emergency use by second gear reduction GR2, with second pinion gear 58, shown as having 12 teeth and third driven gear 60 having 50 teeth, resulting in an additional torque multiplier of 50/12=4.17. As such, second gear reduction GR2 produces a total torque multiplier of 20×4.54×4.17=378.6 during emergency use.

Under normal use condition, the first gear reduction GR1 causes the pawl 34 to move from the ratchet holding position to the ratchet releasing position in X seconds upon actuating the power actuator in the first direction and the second gear reduction GR2 causes the pawl 34 to move from the ratchet holding position to the ratchet releasing position in X+Y seconds upon actuating the power actuator in the second direction, wherein X seconds is less that X+Y seconds.

In FIG. 9, a power latch assembly 110 constructed in accordance with another aspect of the disclosure is shown, wherein like reference numerals, offset by a factor of 100, are used to identify like features.

Power latch assembly 110 includes a first gear reduction GR1 and a second gear reduction GR2 as discussed above for power latch assembly 10, wherein first gear reduction GR1 includes: a drive gear 153, a first driven gear 152 meshed with drive gear 153, a first pinion gear 154, a second driven gear 156 meshed with first pinion gear 154, a second pinion gear 158, and a third driven gear 160 meshed with second pinion gear 158, each structured and interacting as discussed above for power latch assembly 10.

As discussed above, a first drive member 146 is shown fixed to second driven gear 156 for conjoint movement therewith, with first drive member 146 shown being fixed between an outer periphery and a second axis A2 about which second driven gear 156 rotates for operable communication with pawl 34 via a pawl release link 136 during a normal use condition. A second drive member 172 is fixed to the third driven gear 160 for operable driving communication with pawl 34 to move pawl 34 from the ratchet holding position to the ratchet releasing position during an emergency release condition, as discussed above for second drive member 72. Pawl release link 136 is operably coupled to pawl 34 via a pin 170; however, rather than being pivotably fixed to pawl 34 as discussed above for latch assembly 10, pawl release link 136 is configured for lost motion movement with pawl 34 during an emergency release condition.

To provide the lost motion movement between pawl release link 136 and pawl 34, pawl release link 136 has a slot 74 and pin 170, fixed to pawl 34 against relative translation movement therewith, is received in slot 74 for lost motion movement of pin 170 in slot 74 between opposite ends 74a, 74b of slot 74. Pawl release link 136 is supported by pin 170 and is biased by a release link biasing member 144 toward and into engagement with first drive member 146, wherein a hook member 168 at one end of pawl release link 136 is engaged with pin 179 and an opposite end 76 of pawl release link 136 is engaged by a fixed support member 78 fixed to latch housing, such as to latch frame plate 29, by way of example and without limitation. During a normal release operation, pawl release link 136 functions generally the same as discussed above for pawl release link 36, wherein hook member 168 of pawl release link 136 is driven by first drive member 146, thereby causing pawl release link 136 to move from its home position to its pawl release position, whereat end 74a of pawl release link 36 engages pin 170 and moves pawl 32 against the bias of pawl biasing member 42 to its ratchet releasing position (shown in transparency in FIG. 9), whereat ratchet 32 is free to move to the striker release position under the bias of ratchet biasing member 40. Return of pawl release link 136 to its home position is as discussed above for pawl release link 36, and thus, further discussion is believed unnecessary.

Then, in an emergency release condition, second drive member 172, fixed to the third driven gear 160, is driven into operable driving communication with pawl 34 to move pawl 34 from the ratchet holding position to the ratchet releasing position. Second drive member 172 can be configured for direct engagement with pawl 34 or pin 170, as discussed above, thereby directly driving pawl 34 to the ratchet release position (FIG. 8). As pawl 34 is driven from its ratchet holding position to its ratchet releasing position, pawl release link 136 is able to remain fixed or substantially fixed against movement as a result of the lost-motion movement between pawl 34 and pawl release link 136. In particular, pin 170, fixed to pawl 34, is free to translate within slot 74 away from end 74a toward opposite end 74b, as shown in transparency in FIG. 9. Accordingly, the inertia of pawl release link 136 does not factor in movement of pawl 34 to its ratchet releasing position during the emergency release condition, thereby reducing the load needed to cause rotation of third driven gear 160, and further reducing the potential generation of noise. Accordingly, the amount of torque from power release actuator 30 needed to cause release of latch assembly 110 is minimized.

In accordance with another aspect of the disclosure, as shown in FIG. 11, a method 1000 of increasing the output torque of a latch power release actuator 30 of a power latch assembly 10 from a first output torque to an increased second output torque is provided. The method 1000 includes a step 1100 of configuring the power release actuator 30 to rotate an output 48 in a first direction to drive a first power takeoff in a first direction to generate the first output torque, and a step 1200 of configuring the power release actuator 30 to rotate the output 48 in a second direction to drive a second power takeoff in a second direction opposite the first direction to generate the second output torque.

In accordance with a further aspect, the method 1000 can further include a step 1300 of configuring the first power takeoff having a first gear reduction GR1 and configuring the second power takeoff having a second gear reduction GR2.

In accordance with a further aspect, the method 1000 can further include a step 1400 of providing the first gear reduction GR1 having a first driven gear 52 arranged in meshed engagement with the output 48 of the power release actuator 30 and a first pinion gear 54 fixed to the first driven gear 52, and a second driven gear 56 arranged in meshed engagement with the first pinion gear 54.

In accordance with a further aspect, the method 1000 can further include a step 1500 of configuring the second gear reduction GR2 having the first driven gear 52 arranged in meshed engagement with the output 48 of the power release actuator 30 and the second driven gear 56 arranged in meshed engagement with the first pinion gear 54, and a second pinion gear 58 fixed to the second driven gear 56 and a third driven gear 60 arranged in meshed engagement with the second pinion gear 58.

In accordance with a further aspect, the method 1000 can further include a step 1600 of configuring the second driven gear 56 for operable driving engagement with a pawl 34 of the power latch assembly 10 to move the pawl 34 from a ratchet holding position to a ratchet releasing position upon movement of the first power takeoff in the first direction, and configuring the third driven gear 60 for operable driving engagement with the pawl 34 of the power latch assembly 10 to move the pawl 34 from the ratchet holding position to the ratchet releasing position upon movement of the second power takeoff in the second direction.

In accordance with a further aspect, the method 1000 can further include a step 1650 of configuring the second driven gear in operable driving engagement with a pawl via a pawl release link and configuring the pawl release link to move the pawl from a ratchet holding position to a ratchet releasing position upon movement of the first power takeoff in the first direction.

In accordance with a further aspect, the method 1000 can further include a step 1700 of configuring the pawl to move in a lost-motion connection with the pawl release link upon movement of the second power takeoff in the second direction.

In accordance with a further aspect, the method 1000 can further include a step 1800 of configuring an electronic control unit (ECU) in operable communication with the power release actuator 30 and configuring the ECU to signal the power release actuator 30 to change the direction of rotation of the output 48 of the power release actuator 30 from the first direction to the second direction when increased torque is needed to move the pawl 34 from the ratchet holding position to the ratchet releasing direction.

In accordance with a further aspect, the method 1000 can further include a step 1900 of configuring the power release actuator 30 to change the direction of rotation of the output 48 of the power release actuator 30 from the first direction to the second direction automatically when the torque applied to the pawl 34 while the output 48 of the power release actuator 30 is moving in the first direction is insufficient to move the pawl 34 from the ratchet holding position to the ratchet releasing direction.

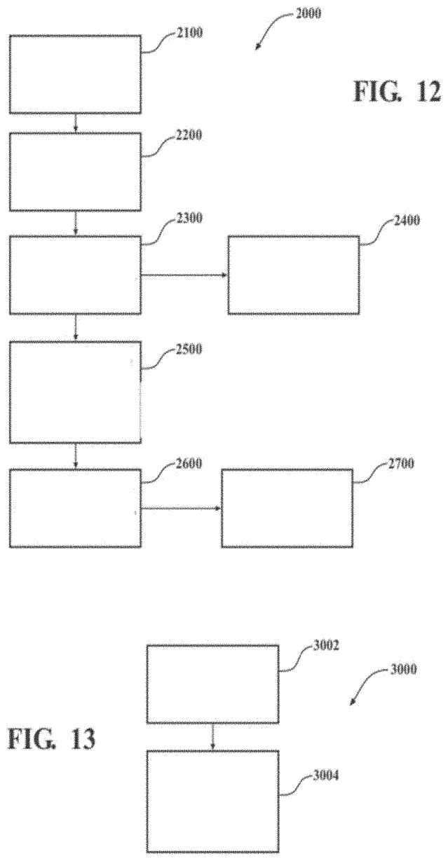

In accordance with another aspect of the disclosure, as shown in FIG. 12, a method 2000 of releasing a power latch assembly 10, 110 of a closure panel of a motor vehicle is provided. The method 2000 includes: a step 2100 of detecting a command to power release the power latch assembly 10, 110; a step 2200 of operating a motor 30 of the power latch assembly 10, 110 in a first mode; a step 2300 of detecting whether the power latch assembly 10, 110 has been released. Step 2300 may include determining if the power latch assembly 10, 110 has not been released after expiry of a predetermined time out; a step 2400 of stopping the motor 30 if the detecting indicates the power latch assembly 10, 110 has been released; a step 2500 of operating the motor 30 of the power latch assembly 10, 110 in a second mode if the detecting indicates the power latch assembly 10, 110 has not been released; a step 2600 of detecting whether the power latch assembly 10, 110 has been released; and a step 2700 of stopping the motor 30 if the detecting indicates the power latch assembly 10, 110 has been released.

According to another aspect of the present disclosure, the method 2000 can further include providing the first mode to include rotating an output 48, 148 of the motor 30 in a first direction and providing the second mode to include rotating the output 48, 148 of the motor 30 in a second direction opposite the first direction.

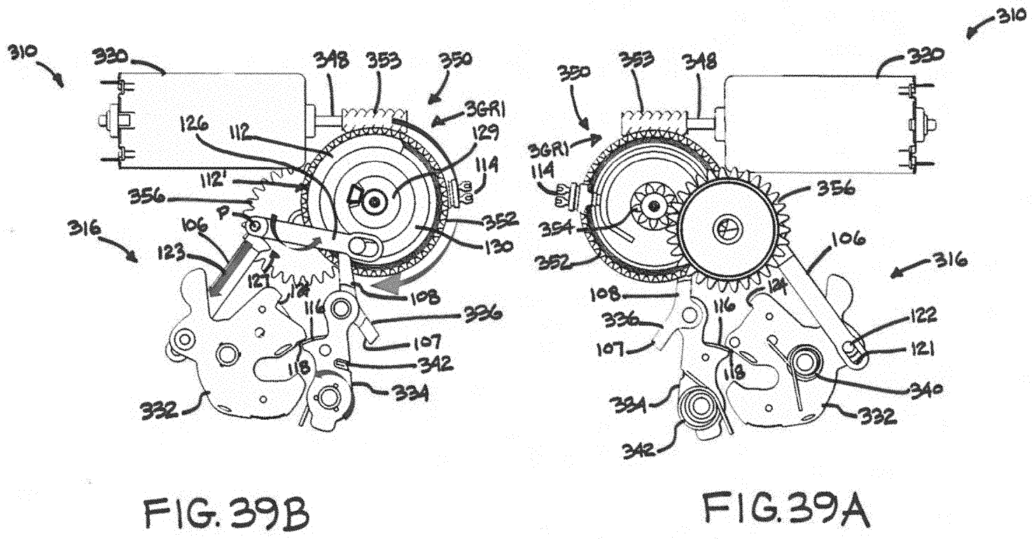

In accordance with another aspect of the disclosure, as shown in FIG. 13, a method 3000 operating a latch power release actuator 30 of a power latch assembly 10 having a first output torque and an increased second output torque is provided. The method 3000 includes a step 3002 of detecting a crash condition of the vehicle, such as by receiving a crash signal from a control unit, such as the ECU 64 receiving a crash or emergency signal from a Body Control Module, as shown as box 39 of FIG. 39, and in response to receiving the signal in step 3004, next operating the power release actuator 30 to couple the increased second output torque to the pawl as described herein above for example, such as by configuring the power release actuator 30 to rotate the output 48 in a second direction to drive a second power takeoff in a second direction opposite the first direction to generate the second output torque. As a result the power from the latch power release actuator 30 is transferred to the pawl using the increased second output torque during an emergency or crash condition. Power and time is therefore not expended by having first to operate the latch power release actuator using the first output torque before again operating the release actuator 30 using the increased second output torque after determining the first output torque is unable to release the latch during the emergency or crash condition of the vehicle.

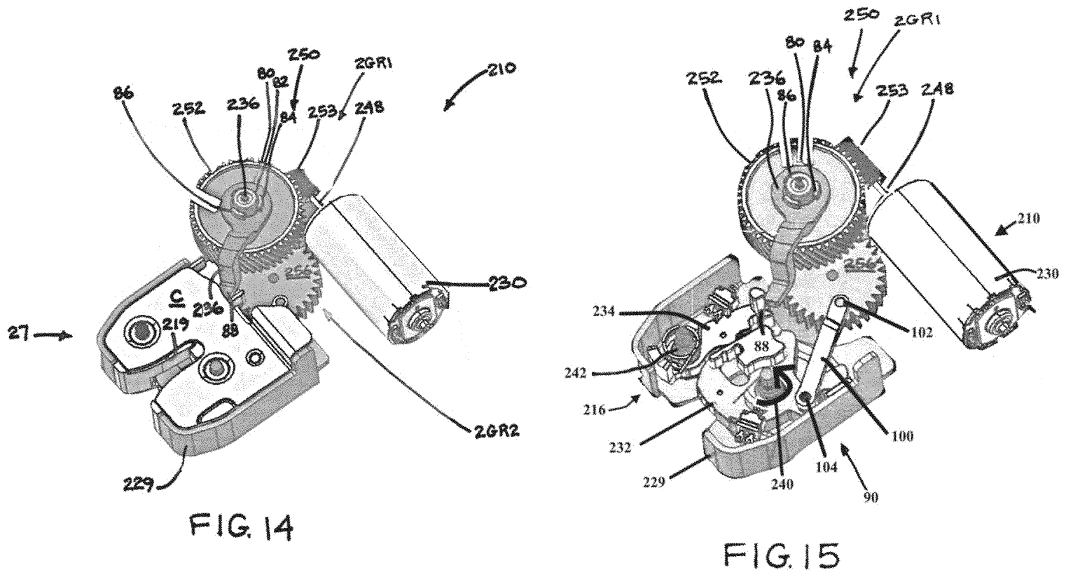

Referring to FIG. 14, shown is another non-limiting embodiment of a compact latch assembly 210 in accordance with the disclosure, wherein the same reference numerals as used above, offset by a factor of 200, are used to identify like features.

As will be detailed, latch assembly 210 is configured to be power-operated via selective actuation of a power release actuator, such as an electric motor 230. For reasons discussed hereafter, power release actuator 230 is able to be minimized in size, weight and power output, thereby enhancing the flexibility of design of the closure panel, while also reducing the cost associated therewith. Further yet, as discussed in further detail below, the power release actuator 230 is configured to move a latch mechanism 216 from a latched state to an unlatched state in quick fashion, and is further configured having sufficient power to move a latch mechanism 216 to a cinched state from a partially latched state, though having a compact size.

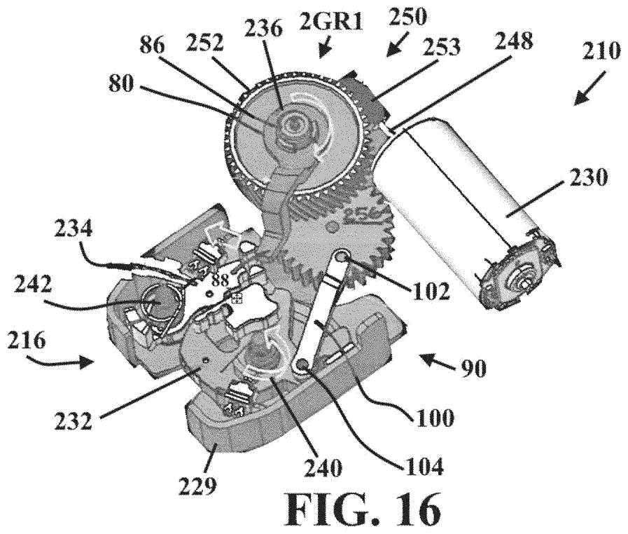

Latch mechanism 216 (FIGS. 15 and 16) is contained in a housing 27 (FIG. 14), having a cover C and a latch frame plate 229, with some components removed for clarity purposes. Latch mechanism 216 includes a ratchet 232 and a pawl 234, and a release lever, also referred to as release link, pawl release lever, or pawl release link 236. Ratchet 232 is movable between a striker capture position, whereat ratchet 232 retains striker 18 with a striker slot of ratchet 232 and swing door 12 in closed position, and a striker release position, whereat ratchet 232 permits release of striker 18 from a fishmouth 219 provided by latch housing 27 of latch assembly 210 to allow movement of swing door 12 to the open position. As discussed above for latch assembly 10, a ratchet biasing member, shown schematically at arrow 240, normally biases ratchet 232 toward its striker release position and pawl 234 is movable between a ratchet holding position, whereat pawl 232 holds ratchet 232 in its striker capture position, and a ratchet releasing position whereat pawl 234 permits ratchet 232 to move to its striker release position. A pawl biasing member 242, such as a suitable spring, is provided to normally bias pawl 234 toward its ratchet holding position.

Pawl release link 236 can be moved to its pawl release position via selective actuation of power release actuator 230. Power release actuator 230 has an output, shown as being provided by an output member, also referred to as output shaft 248, which is operably connected or coupled to pawl 234 via a multistage reduction mechanism 250. Multistage reduction mechanism 250, when driven by power release actuator 230, is configured to move pawl release link 236 to its pawl release position, whereat pawl 234 is moved to its ratchet releasing position.

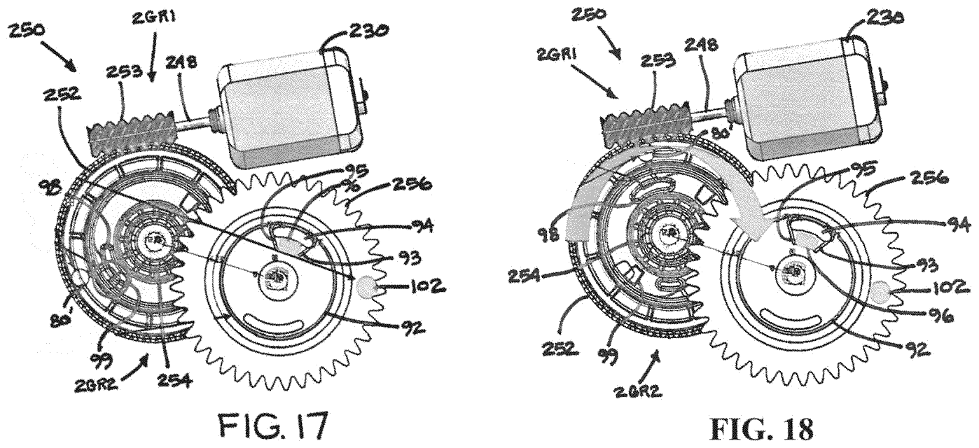

Pawl release link 236 is moved to its pawl release position via a first power takeoff of multistage reduction mechanism 250. Illustratively, multistage reduction mechanism 250 is formed using a geartrain of interconnected gears transferring upstream power from the motor 330 downstream to gears 353, 352, 356. Of course, other numbers of interconnected gears may be provided. First power takeoff is provided by a first gear train 2GR1 including a first driven gear 252 configured in meshed engagement with an output gear, also referred to a main drive gear or drive gear 253, wherein drive gear 253 is shown as a worm gear mounted on output shaft 248 and fixed for conjoint rotation with the output shaft 248 of power release actuator 230. Pawl release link 236 is operably coupled to first driven gear 252 for conjoint movement therewith, as first driven gear 252 is driven from its home position (FIG. 17) to its release position (FIG. 18) in response to drive gear 252 driving first driven gear 252 in a clockwise direction, as viewed in FIGS. 17 and 18. Pawl release link 236 is shown as having a connection hub 80 with a central opening 82 having one or more key features 84 configured for a fixed keyed attachment to a correspondingly keyed hub 86 of first driven gear 252. Keyed hub 86 extends axially along an axis about which first driven gear 252 rotates. Keyed hub 86 is configured to rotate conjointly with first driven gear 252 as it is driven by drive gear 253. Accordingly, upon powered actuation of motor 230 causing drive gear 253 to rotate in a first direction, thereby causing driven gear 252 to be rotated in the clockwise direction from its home position (FIG. 17) to its released position (FIG. 18), pawl release link 236 is driven correspondingly in the clockwise direction, whereupon a drive finger 88 at a free end of pawl release link 236 is brought into driving engagement with pawl 234 to drive pawl 234 against the bias of pawl biasing member 242 to its ratchet release position. Upon moving the pawl 234 to its ratchet release position, motor 230 is powered to causing drive gear 253 to rotate in a second direction opposite the releasing first direction, thereby causing driven gear 252 to be rotated in a counterclockwise direction from its release position back to its home position (FIG. 20). It is to be understood that although pawl release link 236 is shown as being keyed to connection hub 80 of first driven gear 252, that pawl release link 236 can be fixed for conjoint movement with first driven gear 252 via any desired connection arrangement, and is shown schematically in FIGS. 17-18 and 19 as being fixed at a fixation location 80′, which could be provided as a pin connection or otherwise.

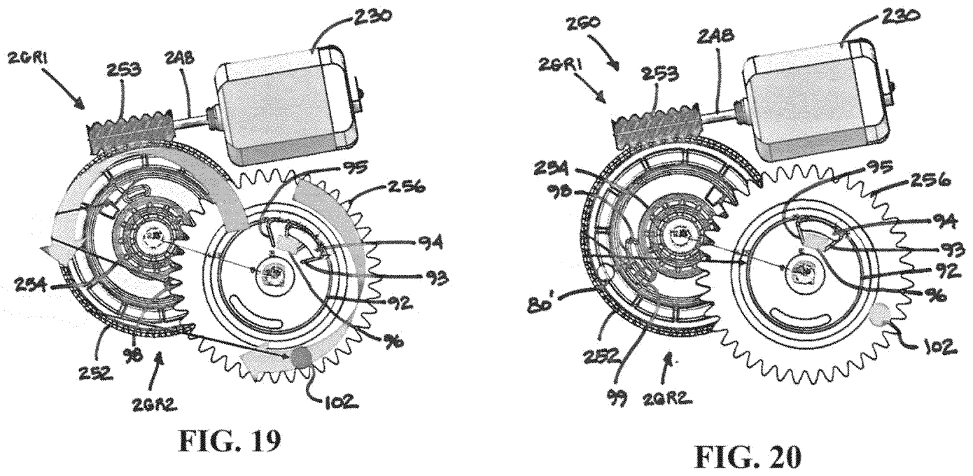

Multistage reduction mechanism includes a second power takeoff configured to drive a power cinch mechanism 90 (FIGS. 16 and 17), with second power takeoff being provided by a second gear reduction 2GR2. Second gear reduction 2GR2 includes, by way of example and without limitation, the first driven gear 252 configured in meshed engagement the drive gear 253 and a second driven gear 256 configured in meshed engagement with a first pinion gear, also referred to as pinion gear 254 (FIGS. 17-20). Pinion gear 254 is configured to remain stationary as first driven gear 252 is rotated clockwise from home position (FIG. 17) to it pawl release position (FIG. 18), thereby causing second driven gear 256 to remain stationary. Meanwhile, when first driven gear 252 is driven counterclockwise (FIG. 19) by drive gear 253, pinion gear 254 is driven conjointly in the counterclockwise direction, thereby causing second driven gear 256 to be driven in a clockwise direction against a spring bias imparted by a biasing member 92, such as a torsion spring. Biasing member 92 acts to maintain second driven gear 256 in its home position (FIGS. 17 and 20) absent being overcome by the driving forced imparted by motor 230 via first driven gear 252, pinion gear 254, and second driven gear 256. Biasing member 92 has a first end 93 biased into fixed engagement with a catch member, also referred to as tab 94, of second driven gear 256 and a second end 95 biased into fixed engagement with a housing tab 96 extending in fixed relation from housing 27. Accordingly, biasing member 92 is maintained under a constant state of bias to maintain second driven gear 256 in its home position absent being moved to a cinch position (FIG. 19) under the power of motor 230. In one possible configuration, multistage reduction stage does not include a clutch mechanism, such as a centrifugal clutch, for transferring power between the motor 230 and the pawl release link 236 which could introduce delays between the activation of the motor 230 and the movement of the pawl release link 236 increasing the time for the pawl 234 to be moved to a releasing position following a motor 230 activation.

To provide a lost motion relationship between first driven gear 252 and pinion gear 254, first driven gear 252 has at least one drive tab 98 and pinion includes at least one driven lug 99. When drive gear 253 drives first driven gear 252 in the clockwise direction, as viewed in FIG. 18, drive tab 98 moves away from driven lug 99, such that pinion gear 254 remains stationary along with second driven gear 256. As such, a cinch link 100, pivotably connected to second driven member 256 at a first location, such as formed at a first end 102 of cinch link 100, and pivotably connected to ratchet 232 at a second location, such as formed at a second end 104 of cinch link 100, interconnects second driven gear 256 with ratchet 232, remains stationary, while pawl release lever 236 is driven conjointly with first driven gear 252 to drive pawl 234 to the ratchet releasing position. It is contemplated that second driven gear 256, upon pawl 234 being moved to the ratchet releasing position, is free to move in lost motion relative to first driven gear 256 as ratchet 232 moves to its striker release position, which can be facilitated via urging of ratchet 232 pulling on second driven gear 256 via cinch link 100. With drive gear 253 being in direct meshed engagement with first driven gear 252, and first driven gear 252 causing direct and conjoint movement of pawl release lever 236, movement of pawl 234 to the ratchet releasing position is quick, while the package size (housing 27) of power latch assembly 210 is compact. Provisioning of the lost motion connection allows for the cinch link 100 to be coupled, such as permanently coupled, with the ratchet 232 to ensure the cinching link 100 does not become disengaged with the ratchet 232 or fails to become engaged with the ratchet 232. Provisioning of the lost motion connection between one of the gears of the multi-stage gear train may provide a direction based or position based activation of the downstream gear, independent of the speed of the upstream gear or motor, which provides a mechanically simpler, less costly, and more reliable coupling configuration compared to known speed activated clutches or the like.

When desired to cinch power latch assembly 210, motor 230 is selectively powered to rotate drive gear 253 in a direction opposite that driven during a release of power latch assembly 210, thereby causing first driven gear 252 to be driven counterclockwise, as viewed in FIG. 19. As first driven gear 252 rotates in the counterclockwise direction, drive tab 98 forcibly drives driven lug 99 of pinion 254 counterclockwise therewith, whereupon pinion gear 254 drives second driven gear 256 in a clockwise direction against the bias imparted by biasing member 92, thus, causing biasing member 92 to become increasingly loaded. As second driven member 256 is driven in the cinching clockwise direction, cinch link 100 forcibly urges ratchet 232 toward the striker capture position to bring latch mechanism 216 to a cinched position. With the gear reduction provided by pinion gear 254 and second driven gear 256, a high force, reduced speed scenario is provided that results in the high force needed to cinch ratchet 232, even with a reduced size and reduced power motor, thereby allowing the package size of the power latch assembly 210 to be minimized.

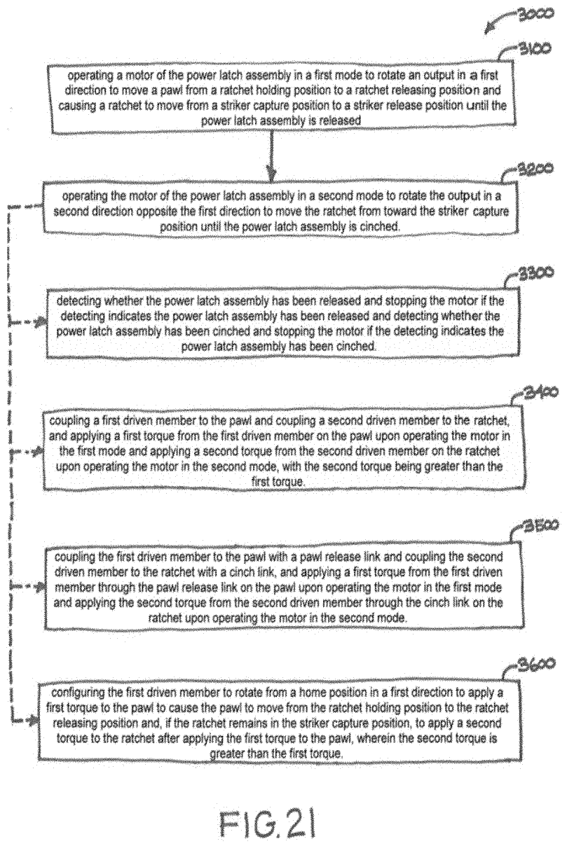

In accordance with another aspect of the disclosure, a method 3000 of releasing a power latch assembly 210, 310 and cinching the power latch assembly 210, 310 of a closure panel 12 of a motor vehicle 14 is shown in FIG. 21. The method 3000 comprises: a step 3100 of operating a motor 230, 330 of the power latch assembly 210, 310 in a first mode to rotate an output 248, 348 in a first direction to move a pawl 234, 334 from a ratchet holding position to a ratchet releasing position and causing a ratchet 232, 332 to move from a striker capture position to a striker release position until the power latch assembly 210, 310 is released; and a step 3200 of operating the motor 230, 330 of the power latch assembly 210, 310 in a second mode to rotate the output 248, 348 in a second direction opposite the first direction to move the ratchet 232, 332 toward the striker capture position until the power latch assembly 210, 310 is cinched.

The method 3000 can further include a step 3300 of detecting whether the power latch assembly 210, 310 has been released and stopping the motor 230, 330 if the detecting indicates the power latch assembly 210, 310 has been released and detecting whether the power latch assembly 210, 310 has been cinched and stopping the motor 230, 330 if the detecting indicates the power latch assembly 210, 310 has been cinched.

The method 3000 can further include a step 3400 of coupling a first driven member 252, 352 to the pawl 234, 334 and coupling a second driven member 256, 356 to the ratchet 232, 332, and applying a first torque from the first driven member 252, 352 on the pawl 234, 334 upon operating the motor 230, 330 in the first mode and applying a second torque from the second driven member 256, 356 on the ratchet 232, 332 upon operating the motor 230, 330 in the second mode, with the second torque being greater than the first torque.

The method 3000 can further include a step 3500 of coupling the first driven member 252, 352 to the pawl 234, 334 with a pawl release link 236, 336 and coupling the second driven member 256, 356 to the ratchet 232, 332 with a cinch link 100, 106, and applying a first torque from the first driven member 252, 352 through the pawl release link 236, 336 on the pawl 234, 334 upon operating the motor 230, 330 in the first mode and applying the second torque from the second driven member 256, 356 through the cinch link 100, 106 on the ratchet 232, 332 upon operating the motor 230, 330 in the second mode.

The method 3000 can further include a step 3600 of configuring the first driven member 352 to rotate from a home position in a first direction to apply a first torque to the pawl 334 to cause the pawl 334 to move from the ratchet holding position to the ratchet releasing position and, if the ratchet 332 remains in the striker capture position, to apply a second torque to the ratchet 332 after applying the first torque to the pawl 334, wherein the second torque is greater than the first torque.

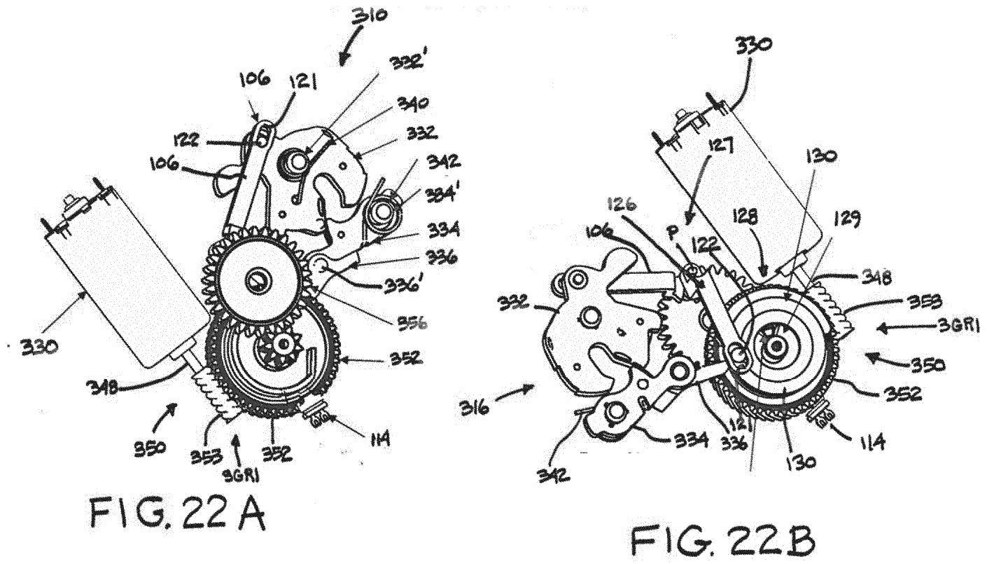

Referring to FIGS. 22A and 22B, another non-limiting embodiment of a compact latch assembly 310 is shown in accordance with the disclosure, wherein the same reference numerals as used above, offset by a factor of 300, are used to identify like features.

As will be detailed, latch assembly 310 is configured to be power-operated via selective actuation of a power release actuator, such as an electric motor 330. For reasons discussed hereafter, power release actuator 330 is able to be minimized in size, weight and power output, thereby enhancing the flexibility of design of the closure panel, while also reducing the cost associated therewith. Further yet, as discussed in further detail below, the power release actuator 330 is configured to move a latch mechanism 316 from a latched state to an unlatched state in a normal powered mode of operation; to move latch mechanism 316 from a latched state to an unlatched state in an ice break powered mode of operation; to move latch mechanism in a power cinch mode, and is further configured to move a latch mechanism 316 from a cinched/latched state to allow manual actuation from the latched state to an unlatched state in a crash unlock/cinch disengage mode, all with the single motor 330. Latch functions such as a latch power release function, a latch cinch function, a latch present/ice break function are illustrative examples of primary latch functions which can cause immediate action on the closure panel 12 such as movement of the closure panel 12 via the cinch and ice breaking/presenting function or allow for the movement of the closure panel 12 through unlatching of the power latch assembly via the power release function. Such primary functions may occur during the usual or regular operation of the power latch assembly e.g. during the normal operating mode of the power latch assembly. Accordingly, the single motor 330 is operable to provide power release actuator 330 having multiple functions for both normal, relative low force release; high force release, such as in ice build-up conditions; cinching, and emergency operations requiring manual release.

Latch mechanism 316 is configured to be contained in a housing (not shown) as discussed above for latch mechanism 216. Latch mechanism 316 includes a ratchet 332 and a pawl 334, and a release lever, also referred to as pawl release link, pawl release lever, secondary pawl or auxiliary pawl 336. Ratchet 332 is movable about a ratchet pin or rivet 332′ between a striker capture position, whereat ratchet 332 retains striker 18 with a striker slot of ratchet 332 and swing door 12 in closed position, and a striker release position, whereat ratchet 332 permits release of striker 18 from a fishmouth provided by latch housing of latch assembly 310 to allow movement of swing door 12 to the open position. As discussed above for latch assembly 10, a ratchet biasing member 340, such as a suitable spring, normally biases ratchet 332 toward its striker release position, and pawl 334, in response to movement of auxiliary pawl 336, is movable about a pawl pin or rivet 334′ between a ratchet holding position, whereat pawl 332 holds ratchet 332 in its striker capture position, and a ratchet releasing position whereat pawl 334 permits ratchet 332 to move to its striker release position. In addition to ratchet biasing member 340, should increased resistance be acting on ratchet 332, such as from a build-up of ice, by way of example and without limitation, a first link, also referred to as cinch/ice brake link 106, is provided to act on ratchet 332 to overcome any such increased force on ratchet 332 to facilitate forcible movement of ratchet 332 to the striker release position, as discussed further below. A pawl biasing member 342, such as a suitable spring, is provided to normally bias pawl 334 toward its ratchet holding position.

To affect power release of latch mechanism 316, auxiliary pawl 336 can be moved to a pawl release position via selective actuation of power release actuator 330. Power release actuator 330 has an output, shown as being provided by an output member, also referred to as output shaft 348, which is operably connected or coupled to pawl 334 via auxiliary pawl 336 and a multistage reduction mechanism 350. Multistage reduction mechanism 350, when driven by power release actuator 330, is configured to move auxiliary pawl 336 to its pawl release position, whereat pawl 334 is moved to its ratchet releasing position, as discussed in more detail below.

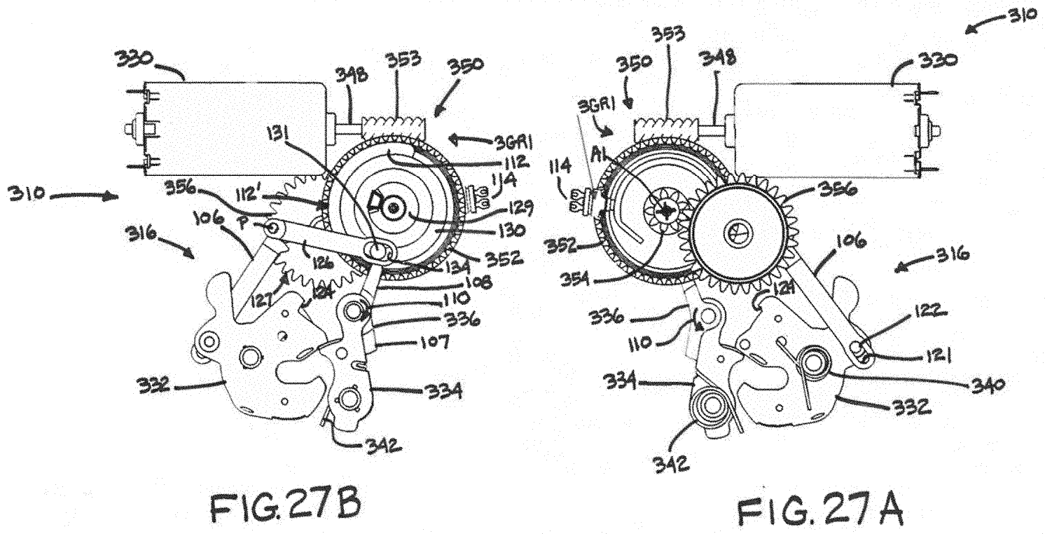

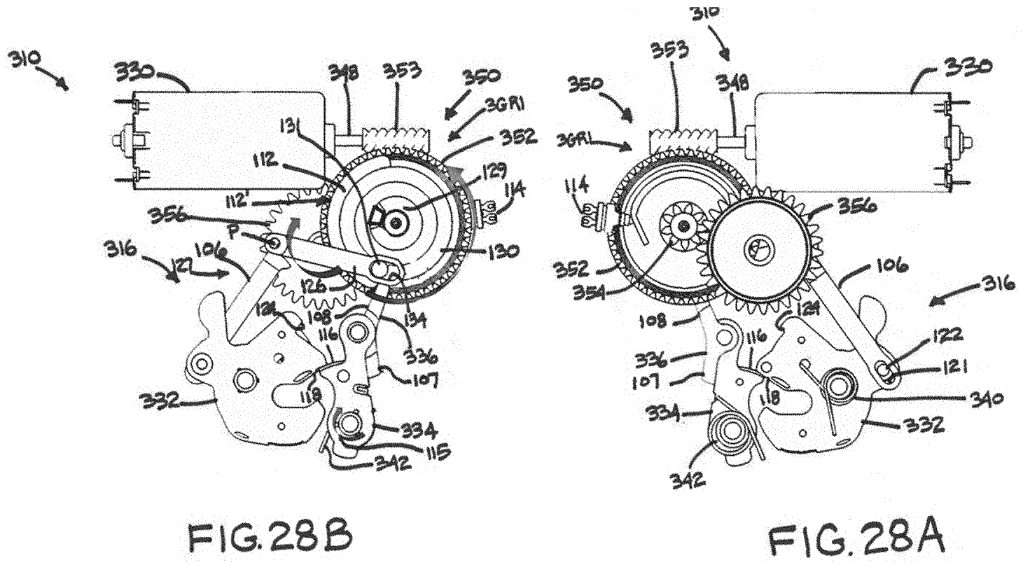

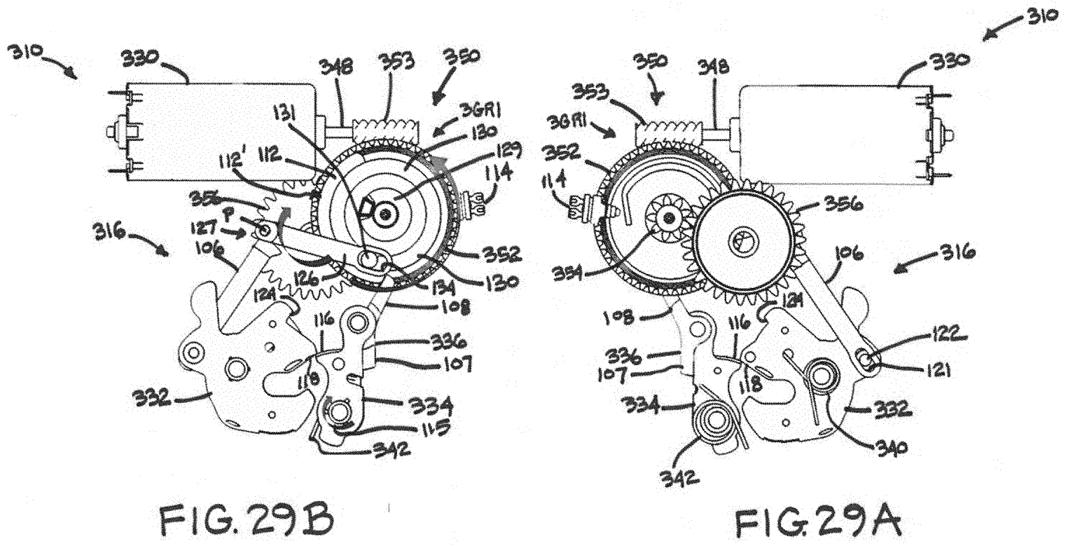

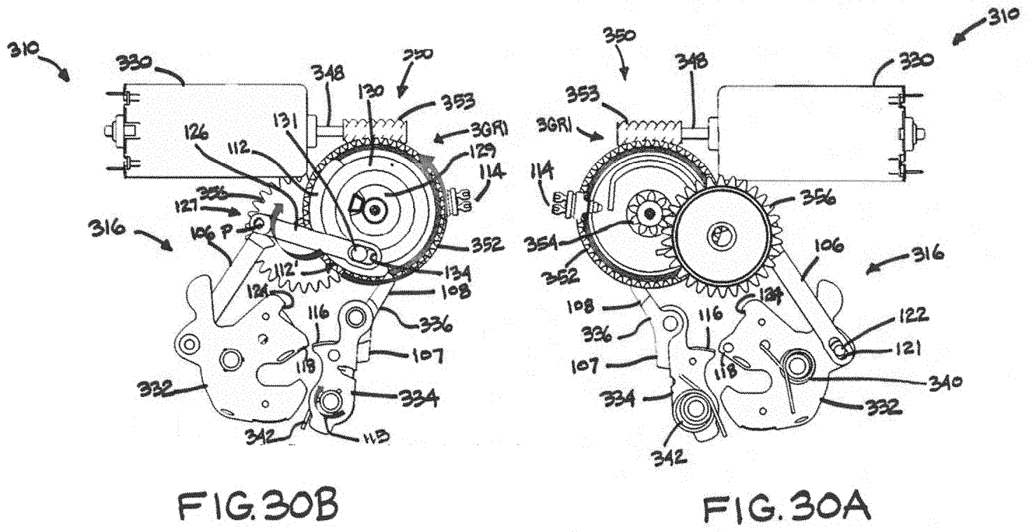

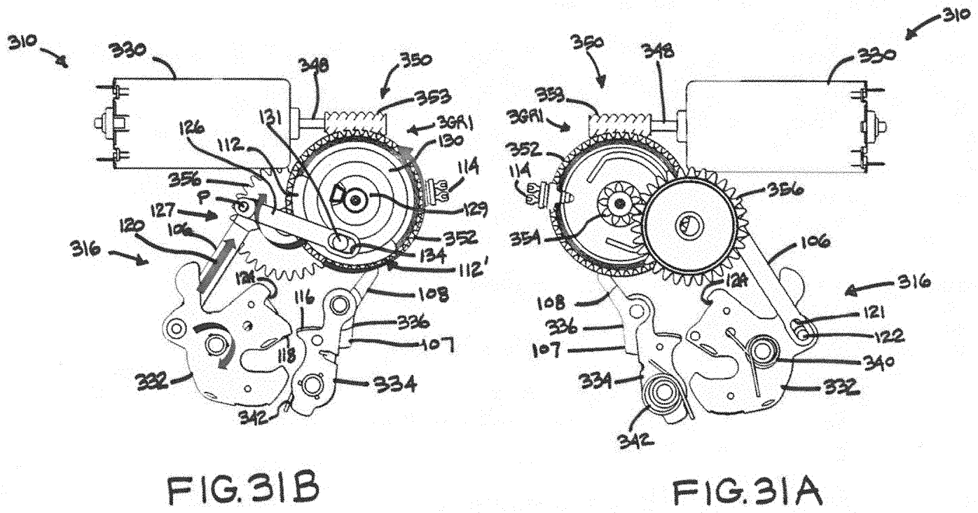

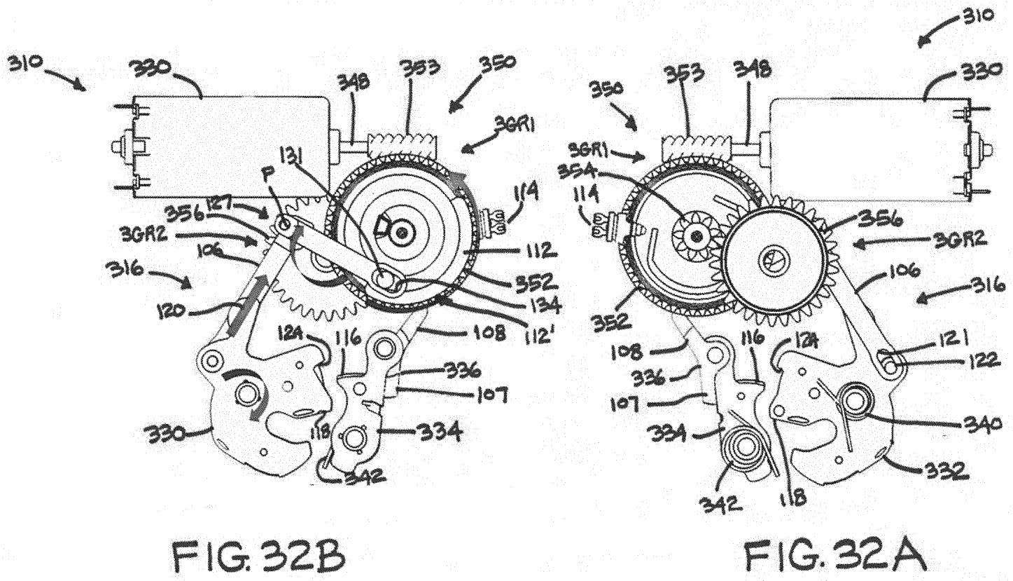

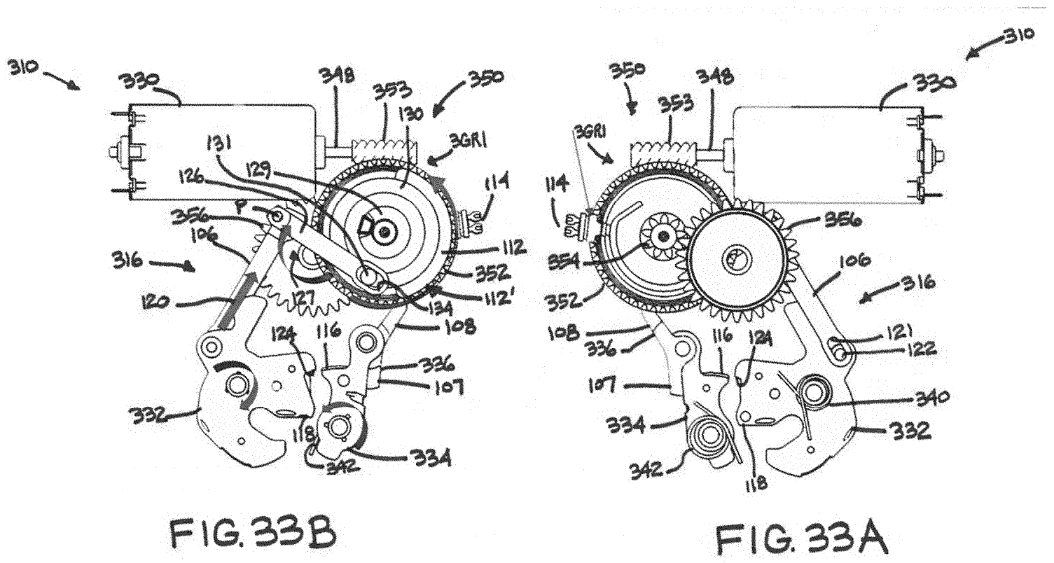

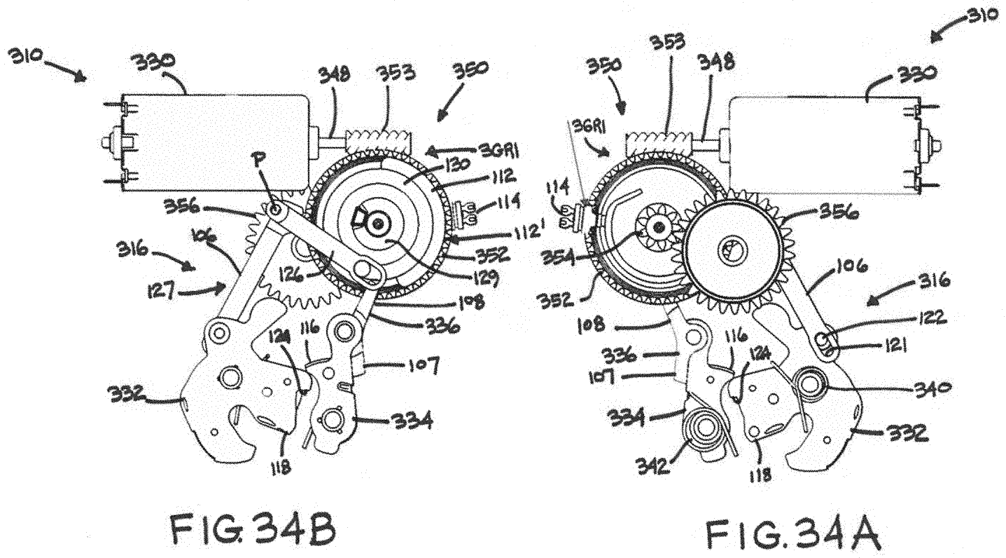

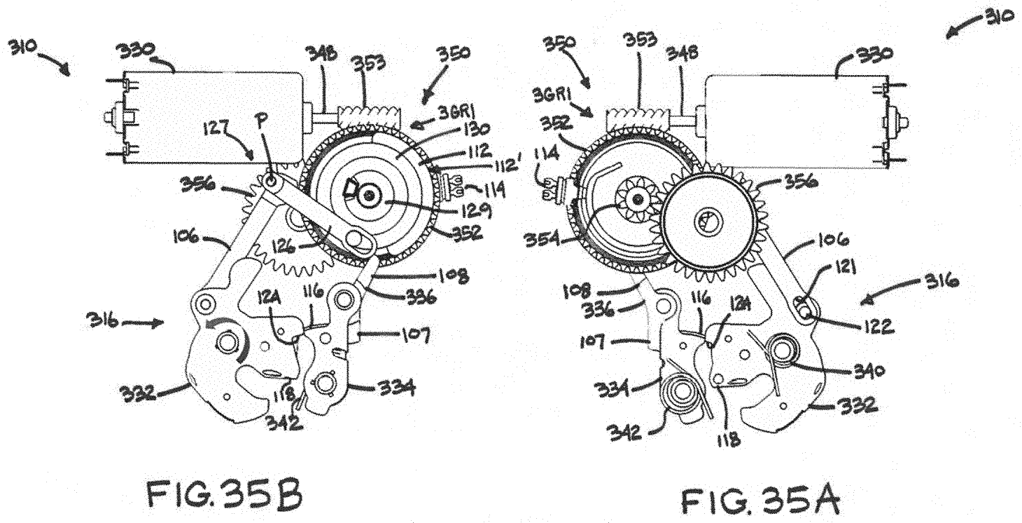

Auxiliary pawl 336 is moved to its pawl release position via a first power takeoff of multistage reduction mechanism 350. First power takeoff is provided by a first gear set, also referred to as first gear train 3GR1, including first stage gear set having a first driven gear 352, configured in meshed engagement with an output gear, also referred to a main drive gear or drive gear 353, wherein drive gear 353 is shown as a worm gear mounted on output shaft 348 and fixed for conjoint rotation with the output shaft 348 of power release actuator 330. Auxiliary pawl 336 is operably coupled to first driven gear 352 for driven movement of auxiliary pawl 336, thereby driving pawl 334 toward the ratchet releasing position, as first driven gear 352 is driven from its home position (FIGS. 27A and 27B) to its release position (FIGS. 34A and 34B) in response to drive gear 352 driving first driven gear 352 in a counterclockwise direction, as viewed in FIGS. 28B through 34B. Auxiliary pawl 336 is shown as being pivotably coupled to a free end of pawl 334 by an auxiliary pawl pin or rivet 336′ (FIG. 22A) for selective pivotal movement about auxiliary pawl pin 336′. Auxiliary pawl 336 has a first arm 107 and a second arm 108 extending generally away from one another and away from auxiliary pawl pin 336′. First arm 107 extends along pawl 334 in side-by-side relation, wherein auxiliary pawl 336 is biased in a clockwise direction, as viewed in FIGS. 26 and 27B, by an auxiliary pawl biasing member 110 (FIGS. 26-27B), such as a suitable spring member, to bias first arm 107 into engagement with a stop surface of pawl 334, such that any driven movement of auxiliary pawl 336 in the same clockwise bias direction by first driven gear 352 causes conjoint movement of pawl 334 with auxiliary pawl 336. Second arm 108 extends toward first driven gear 352 to a driven free end for selective engagement with a cam member, also referred to as drive member 112, fixed to first driven gear 352. In FIG. 26A, an alternate embodiment of auxiliary pawl 336′ is shown having a friction reduction member at the free end of second arm 108′, wherein friction reduction member is shown as a roller 109 configured for rolling engagement with cam member 112. Drive member 112 is shown as an arcuate, elongate member, having a radially outwardly facing (relative to a first axis A1 about which first driven gear 352 rotates) constant radius drive surface 112′ configured to releasably maintain auxiliary pawl 336 in a fully deployed position (FIGS. 31B-33B) during a portion of normal powered actuation of latch mechanism 316 to releasably hold pawl 334 in the ratchet releasing position. Drive member 112 is circumferentially discontinuous, shown as extending about 180 degrees about first driven gear 352, by way of example and without limitation, though it is contemplated that the circumferential extent of drive member 112 could be between about 45-270 degrees. Accordingly, upon powered actuation of motor 330 causing drive gear 353 to rotate in a first direction, thereby causing first driven gear 352 to be rotated in the counterclockwise direction from its home position (FIG. 27B) to its released position (FIG. 34B), auxiliary pawl 336 is driven correspondingly in the clockwise direction, whereupon first arm 107 of auxiliary pawl 336 drives pawl 334 against the bias of pawl biasing member 342 to its ratchet release position. Upon moving the pawl 334 to its ratchet release position, striker 18 is free to be removed from ratchet 332.

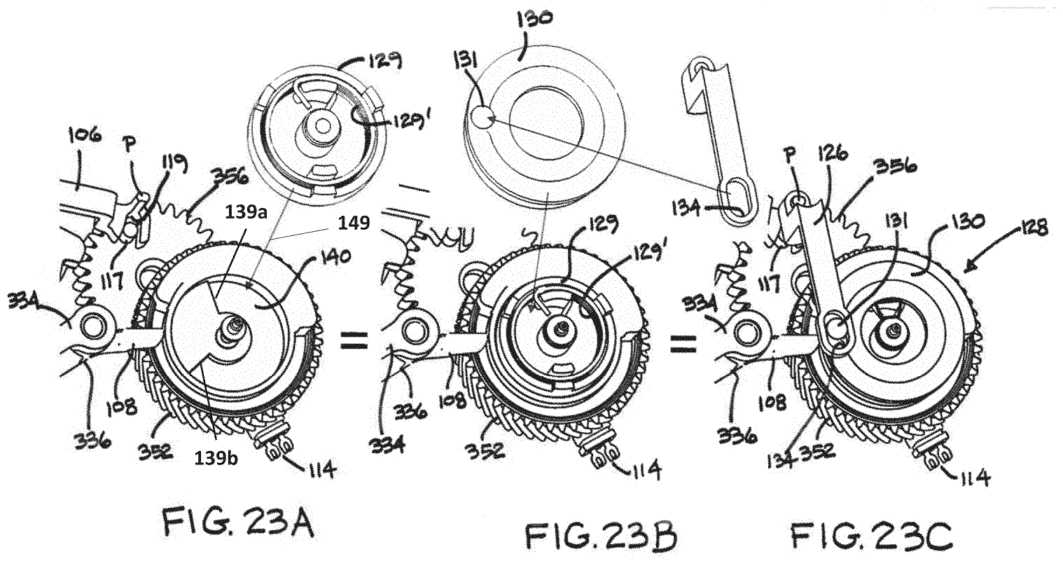

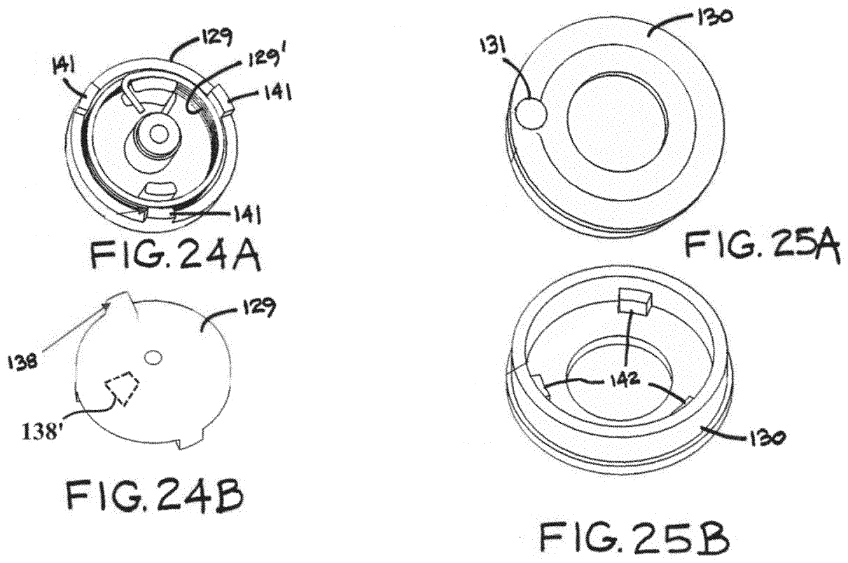

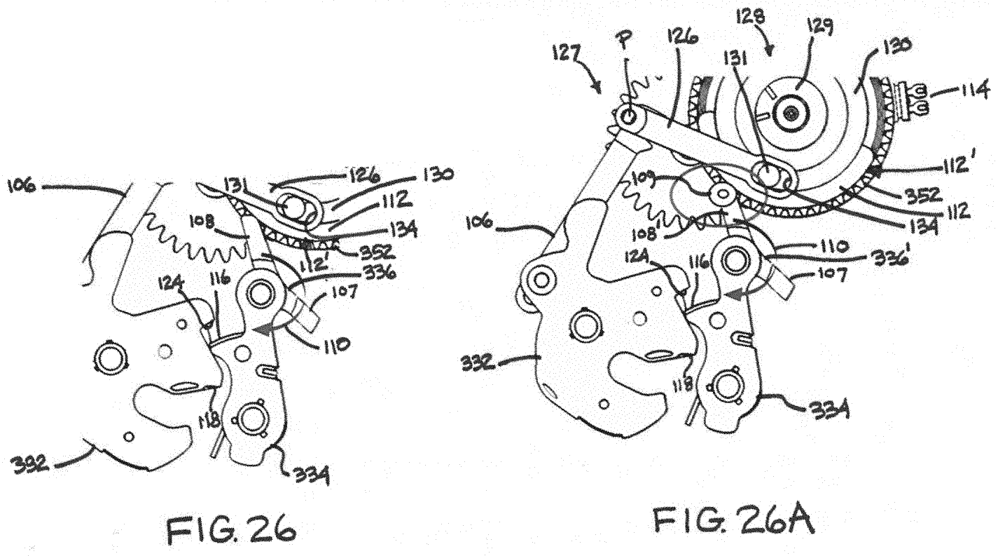

In more detail, in FIGS. 27A and 27B, closure latch assembly 310 is illustrated in the closed position. A home position sensor/switch 116 detects and communicates the presence of first drive gear 352 in the home position to a control module/ECU, such as latch ECU 64, by way of example and without limitation. Upon latch ECU 64 receiving a signal, such as from a proximity sensor based entry feature as discussed above, for example when a person approaches vehicle 14 with electronic key fob 28 (FIG. 2), latch ECU 64 actuates power release motor 330 to rotate the output shaft 348 and drive gear 353, thereby causing first driven gear 352 to be rotated in a first direction, shown as counterclockwise in FIGS. 28B-33B. As first driven gear 352 rotates, drive member 112 engages second arm 108 of auxiliary pawl 336 to rotate auxiliary pawl 336 in a clockwise direction, as viewed in FIGS. 28B-33B, thereby causing first arm 107 or auxiliary pawl 336 to forcibly rotate pawl 334 in the clockwise direction, indicated by arrow 115, against the bias of pawl biasing member 342. In FIG. 29A and 29B, a locking surface 116 of pawl 334 is shown being moved out of engagement from a primary lock notch 118 of ratchet 332, and in the absence of any undue restriction on ratchet 332, ratchet 332 is free to move under the bias of ratchet biasing member 340 to the striker release position. However, if undue force of resistance, such as in the form of friction or build-up of ice, or any other foreign substance is present, tending to inhibit ratchet 332 from moving under the bias of ratchet biasing member 340 to the striker release position, continued movement of first driven gear 352 in the counterclockwise direction causes an increased force, generated by a second power takeoff provided, at least in part, by a second gear train 3GR2, to be imparted by a on ratchet 332 to overcome the force of resistance to move ratchet 332 to the striker release position and shift latch assembly 310 to the unlatched operating state so as to facilitate subsequent opening of vehicle door 12. Second gear train 3GR2 of second power takeoff includes a pinion gear 354 fixed to the first driven gear 352, shown as being fixed concentrically therewith for rotation about a common first axis A1 (FIG. 27A), and a second stage gear set having a second driven gear 356 configured in meshed engagement with the pinion gear 354. As first driven gear 352 continues to rotate in the counterclockwise direction, as viewed in FIGS. 28B-33B, second driven gear 356 is caused to rotate clockwise in an opposite direction at a slower rotational speed and at a higher torque compared to first driven gear 352. As second driven gear 356 rotates, the cinch/ice break link 106, which is pivotably and detachably coupled to second driven gear 356 for conjoint movement therewith via a pin 117 fixed to second driven gear 356, with pin 117 being releasable captured in a slot 119 formed between forked fingers of cinch/ice break link 106 adjacent an end of cinch/ice break link 106 (best shown in FIG. 23A), is pulled along a direction of arrow 120 (FIGS. 31B-33B), whereupon ratchet 332 experiences an increased torque sufficient to overcome any initial resistance inhibiting ratchet 332 from rotating under the force applied by ratchet biasing member 340. Accordingly, ratchet 332 is able to move from the striker capture position to the striker release position under normal conditions via pawl 334 moving to its ratchet releasing position and via the first torque force applied by ratchet biasing member 340, and if a sufficient resistance force prevents ratchet 332 from moving to its striker release position, then ratchet 332 is immediately caused to move to its striker release position under a significantly increased second torque applied by second driven gear 356 and cinch/ice break link 106. If ratchet 332 is not inhibited from movement by factors causing an increased resistance, e.g. ice build-up, it is to be recognized that ratchet 332 is uninhibited by cinch/ice break link 106 from moving freely to the striker release position under the bias of ratchet biasing member 340. In one possible configuration, multistage reduction mechanism 350 may not include a clutch mechanism such that gears 353, 352, 354 are in constant meshed and synchronized arrangement with one another, allowing for direct movement of each gear 353, 352, 354 in either one of an associated counterclockwise and clockwise direction when the motor 330 is driven in either of its two operational directions.

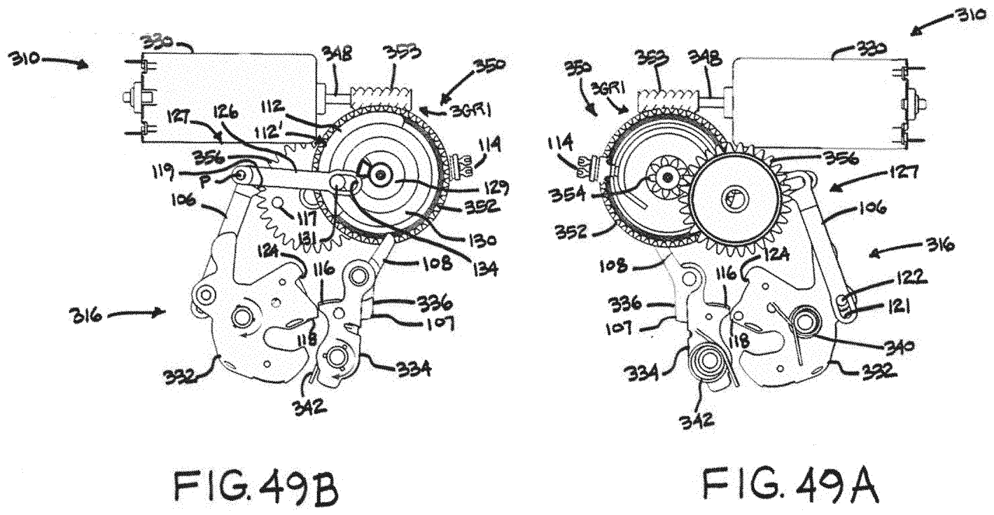

The free movement of ratchet 332 to the striker release position is facilitated by a lost-motion connection between cinch/ice break link 106 and ratchet 332 via a slot 121 and pin 122 coupling at the attachment location to ratchet 332 (FIGS. 27A-50A), wherein pin 121 is able to translate from one end of slot 121 toward an opposite end of slot 121 over a sufficient distance to prevent any binding between cinch/ice break link 106 and ratchet 332 during movement of ratchet 332 to the striker release position under the bias of ratchet biasing member 340, as shown in FIGS. 28A-30A. However, if the increased torque, above and beyond the force applied by ratchet biasing member 340, is needed to move ratchet 332 to the striker release position, pin 122 is moved immediately adjacent an end of slot (FIG. 31A) such that the end of slot 121 engages pin 122 as the second driven gear continues to rotate in response to continued rotation of first driven gear 152 toward the fully deployed position (FIGS. 34A and 34B) of first driven gear 352. Further, it is to be recognized that as first driven gear 352 is rotating from FIG. 30B to FIG. 33B, pawl 334 is held in the ratchet releasing position by drive member 112, and thus, pawl 334 does not interfere with the ability of ratchet 332 to move to the striker release position via assistance from cinch/ice break link 106, and then, upon ratchet 332 reaching the striker release position (FIG. 34B), drive member 112 is moved beyond the second arm 108 of pawl 334, thereby allowing pawl 334 to return automatically under the bias of pawl biasing member 342 to the ratchet holding position (FIGS. 34A and 34B).

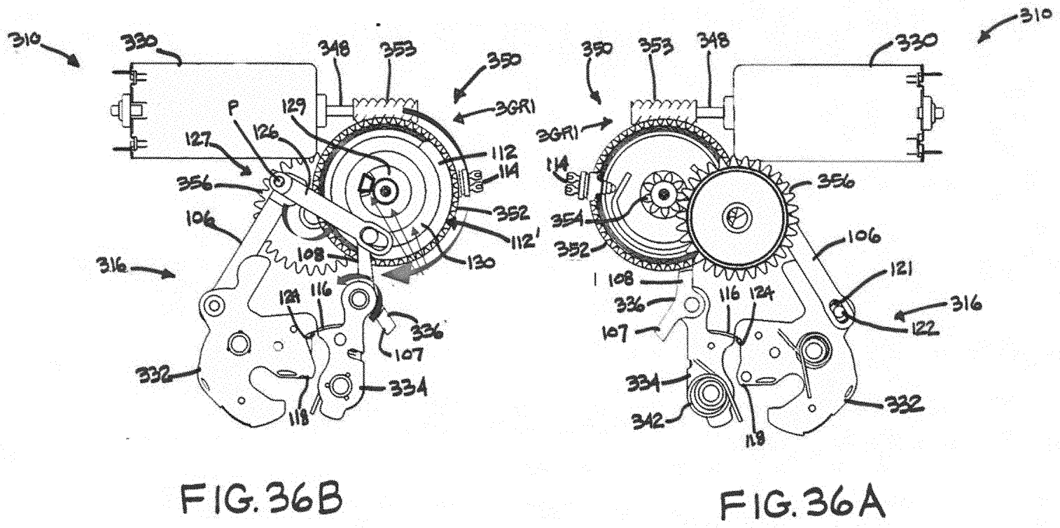

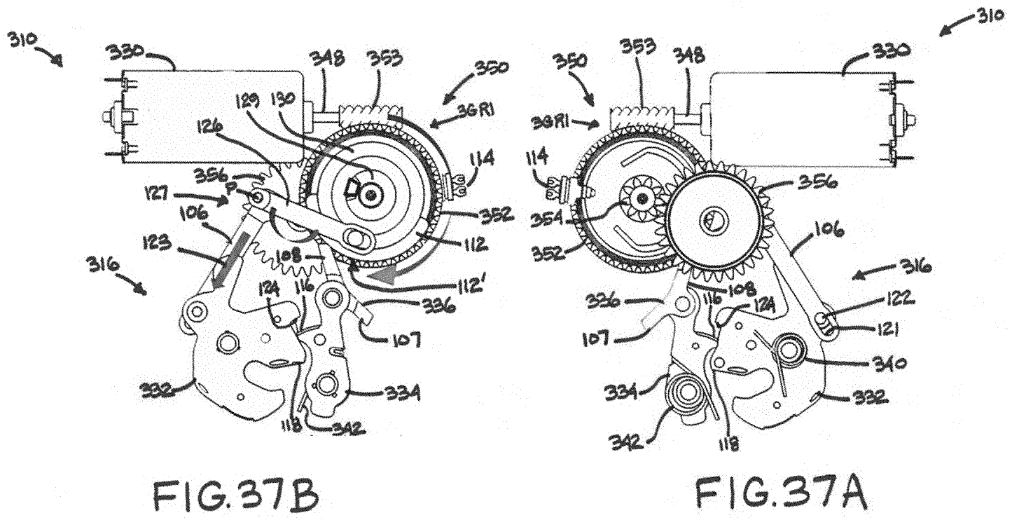

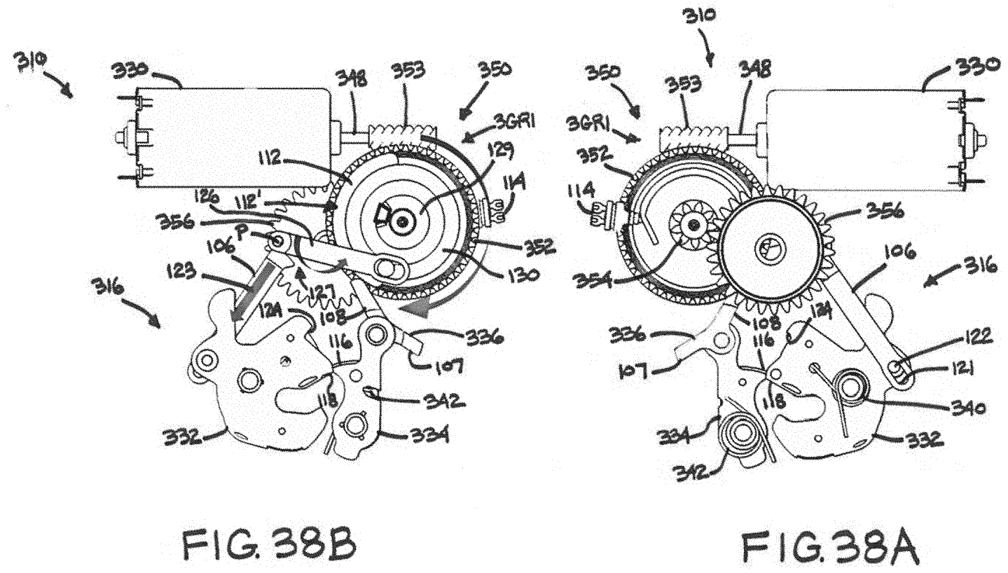

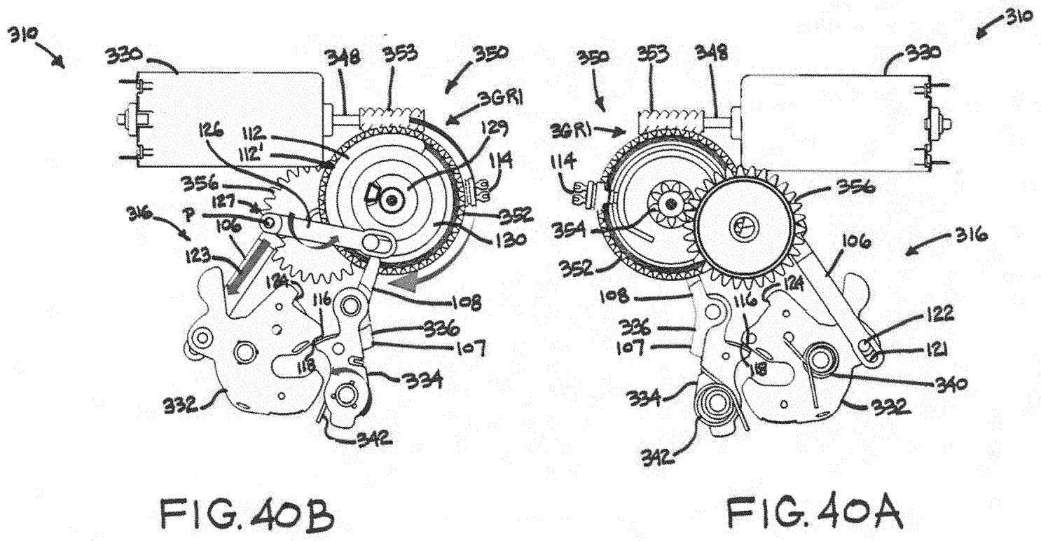

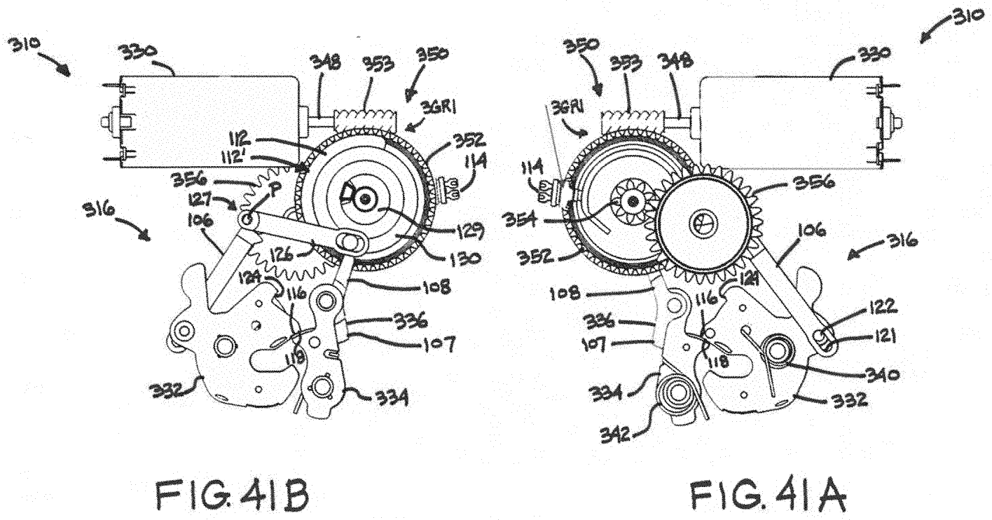

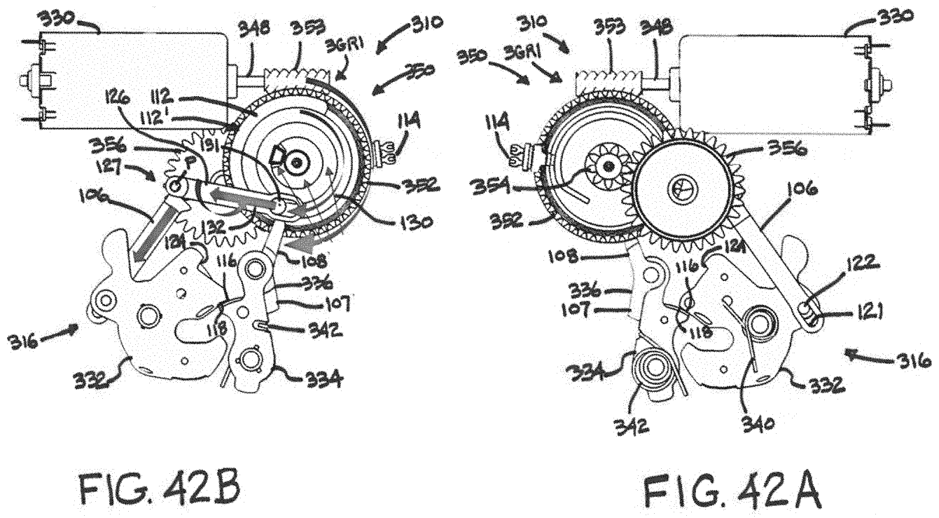

With the closure latch assembly 310 in the open position (FIGS. 34A and 34B), ratchet 332 is ready to receive the striker 18 as the hood is manually closed to a cinch start position (FIGS. 35A and 35B). Upon the striker 18 forcibly urging the ratchet 332 to the cinch start position, which is proximate but shown as just shy of a secondary closed position, whereat pawl 334 is engaged with a secondary lock notch 124 of ratchet 332, power motor 330 is energized, such as via a signal sent to latch ECU 64 from a sensor configured to detect a relative position of ratchet 332, by way of example and without limitation. Power motor 330 drives first driven gear 352 in a clockwise direction, as viewed in FIGS. 36B-40B, thereby causing drive member 112 of first driven gear 352 to forcibly engage second arm 108 of auxiliary pawl 336 and pivot auxiliary pawl 336 counterclockwise against the bias of auxiliary pawl biasing member 110, as shown in FIG. 36B, thus allowing a bypass of pawl 334 as auxiliary pawl 336 rotates relative to pawl 332. As first driven gear 352 is driven by drive gear 353, pinion gear 354 drives second driven gear 356 in the counterclockwise direction, as viewed in FIGS. 36B-40B, thereby causing cinch/ice break link 106 to be forcibly pushed via the fixed pivotal connection with second driven gear 356. As cinch/ice break link 106 is pushed, pin 122 fixed to ratchet 332 translates through slot 121 until it engages an end of slot 121 (FIG. 37A), whereat movement of cinch/ice break link 106 along a direction of arrow 123 begins to forcibly pivot ratchet 332 in a cinching process (FIGS. 37B-40B) toward the striker capture position (FIG. 40B). Upon ratchet 332 being rotated sufficiently, pawl 334 is urged by pawl biasing member 342 to return to the ratchet holding position (FIGS. 39B and 40B), and upon first driven gear 332 rotating to the home position (FIG. 41A and 41B), drive member 112 moves out from engagement from second arm 108 of auxiliary pawl 336, whereupon auxiliary pawl 336 is urged under the bias of auxiliary pawl biasing member 110 to return first arm 107 into engagement with a stop surface of pawl 332 (FIGS. 40B and 41B). With first drive gear 352 returned to the home position, latch ECU 64 is signaled by sensor 114 to de-energize motor 330.

Accordingly, the actuation of the single motor 440, as discussed above, results in a “normal” mode of power release; an “ice break” mode of power release (under an increased torque relative to the normal mode when needed to move ratchet 332 to the striker release position), and a “power cinch” mode of power latching. The ice break/present function operates to move the closure panel 12 from the closed position to a partially presented position, for example between 35 to 75 mm distance away from the fully closed position of the closure panel 12, using an extendable and retractable member, such as a plunger as one example, or by powered action upon the ratchet in a manner as described herein in accordance with another illustrative example. Ice break/present function maybe operated to assist with the door opening during low temperatures, when ice build-up prevents normal opening of the closure panel 12, following a crash, or to assist with overcoming high seal loads as non-limiting examples.

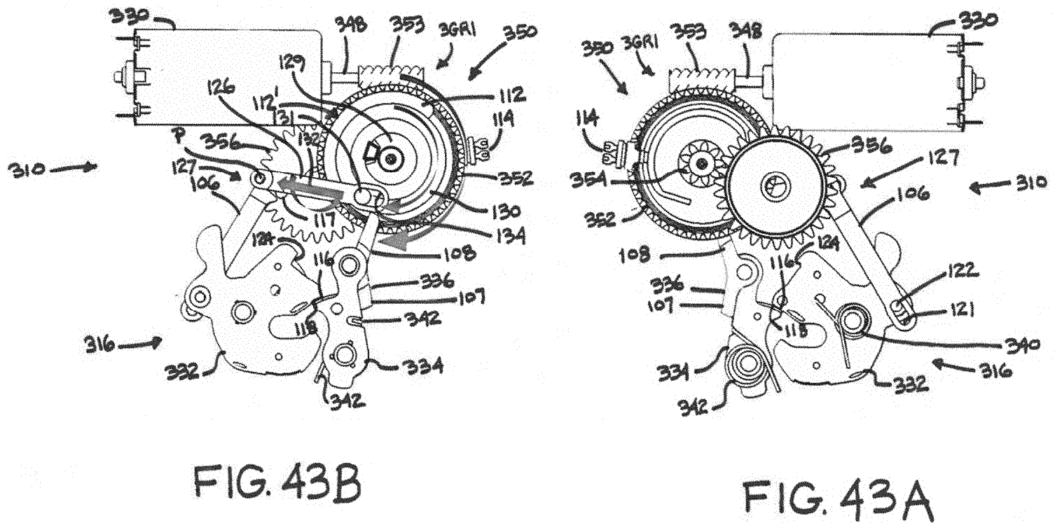

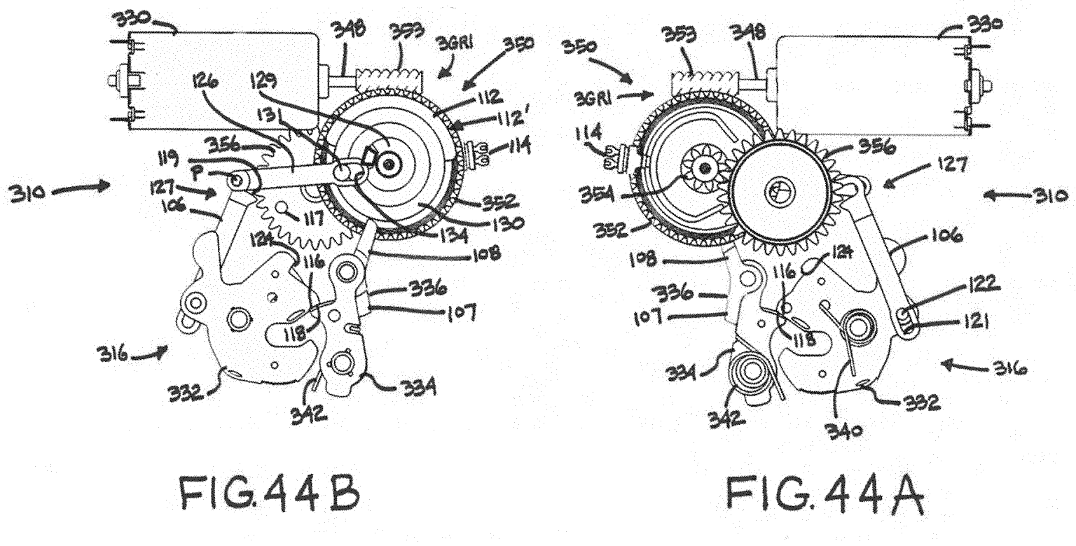

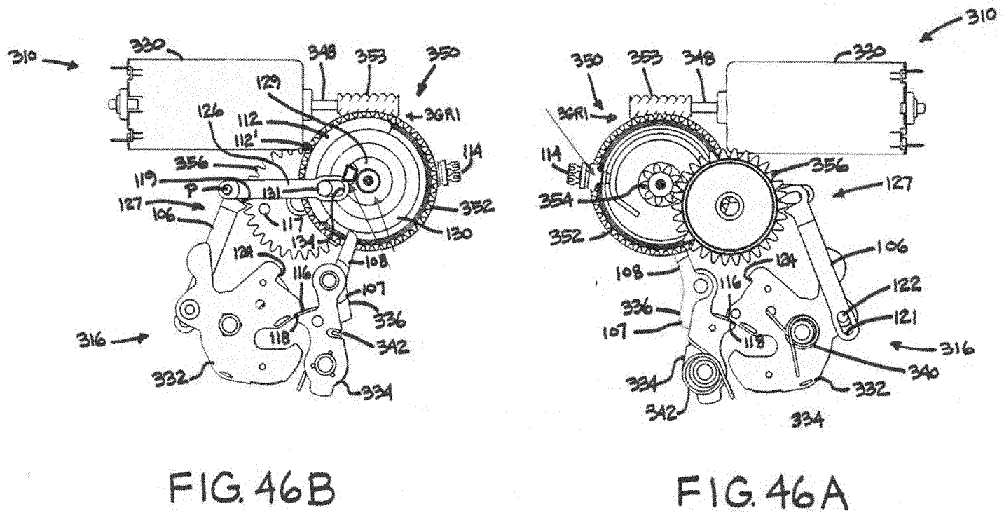

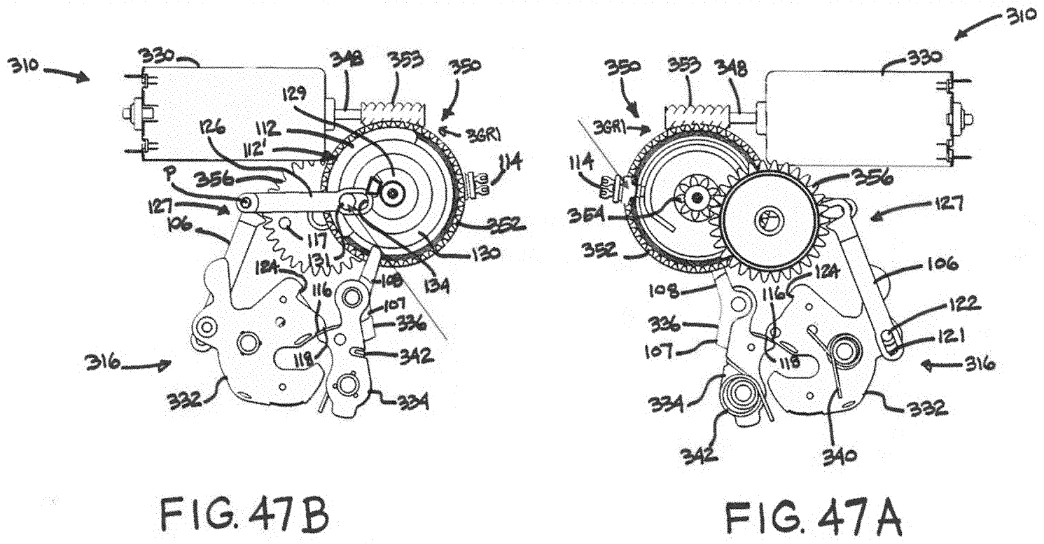

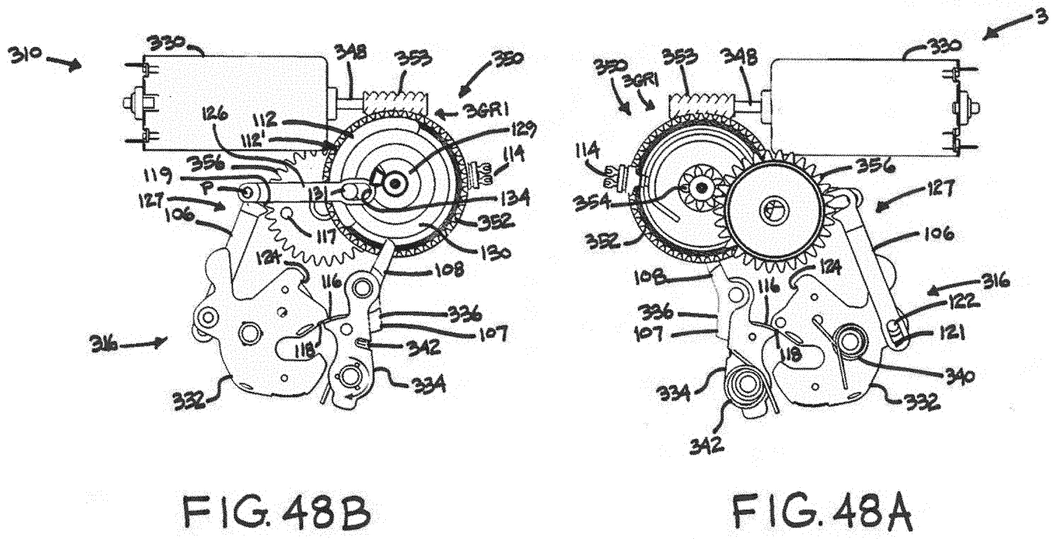

In accordance with a further aspect, when manual release of closure latch assembly 310 is desired and/or needed, such as in a crash condition, by way of example and without limitation, motor 330 can be energized, such as in response to a signal detecting a crash condition, to transition latch mechanism 316 to a manual release mode (FIGS. 46A-50B). Motor 330, rather than being energized to rotate first driven gear 352 in the direction discussed above for a power release operation, is energized to drive first driven gear 352 in a clockwise direction, as viewed in FIGS. 42B and 43B, whereupon second driven gear 356 is driven in the counterclockwise direction, and a second link, also referred to as cinch disengage link 126, is driven by a crash unlock lever 127 to disengage cinch/ice break link 106 from pin 117 (FIGS. 44A-50B), whereat ratchet 332 is disengaged from first gear set 3GR1, second gear set 3GR2, and motor 330, thereby being configured for manual release to the striker release position upon manual movement of pawl 334 to the ratchet releasing position (FIG. 48A-50B). Second link 126 is thus configured to operably couple the first driven gear 352 to the first link 106 to move first link 106 into and out of coupled relation with second driven gear 356, as discussed further below. Together, first link 106 and second link 126 for a link assembly 127, wherein an end of second link 126 is shown coupled to a pin P of first link 106 to maintain first and second links 106, 126 in pivotably coupled relation with one another. Latch functions such as a manual release function, a cinch disengage function and a crash unlock function as an example of an unlock function, are illustrative examples of secondary latch functions which can facilitate subsequent action, such as a user input on a handle for causing a manual release of the latch or a backup power release using power from a backup energy source such as a supercapacitor or battery for causing a backup electronic release of the latch, to subsequently cause or allow as movement of the closure panel 12. Some illustrative examples of a backup power release using power from a backup energy source is described in U.S. Pat. Nos. 10,138,656, 10,378,251, and 10,654,374, the entire contents of which are incorporated herein by reference. Such functions may occur during an unusual or atypical operation of the power latch assembly in an extended operating mode which may occur for example during a crash or emergency or servicing state of the power latch assembly or vehicle. Such functions may in possible configurations only be required in irregular conditions and may optionally allow to override the primary latch functions when the latch is in the extended operating mode. It is recognized that secondary latch functions may include more regular occurring functions such as disablement/enablement of a double pull state of the latch, enablement or disablement of a double lock function of the latch (another example of an unlock function), enablement of a presenting function, which are non-limiting examples.

To facilitate movement of cinch disengage link 126 in response to movement of first driven gear 352 in the clockwise direction, a central hub assembly 128 is provided in a lost-motion coupled arrangement with first driven gear 352, such that hub assembly is driven conjointly with first driven gear 352 in the clockwise direction, thereby driving cinch disengage link 126 and causing cinch/ice break link 106 to become decoupled from pin 117 providing a disengagement function of the cinch/ice break link 106 from the motor 330 and geartrain. In contrast, while first driven gear 352 is driven in the counterclockwise direction during normal use, central hub assembly 128 remains stationary or substantially stationary, whereby cinch disengage link 126 allows cinch/ice break link 106 to remain coupled with pin 117 in order to perform ice break and cinch functions, as discussed above.

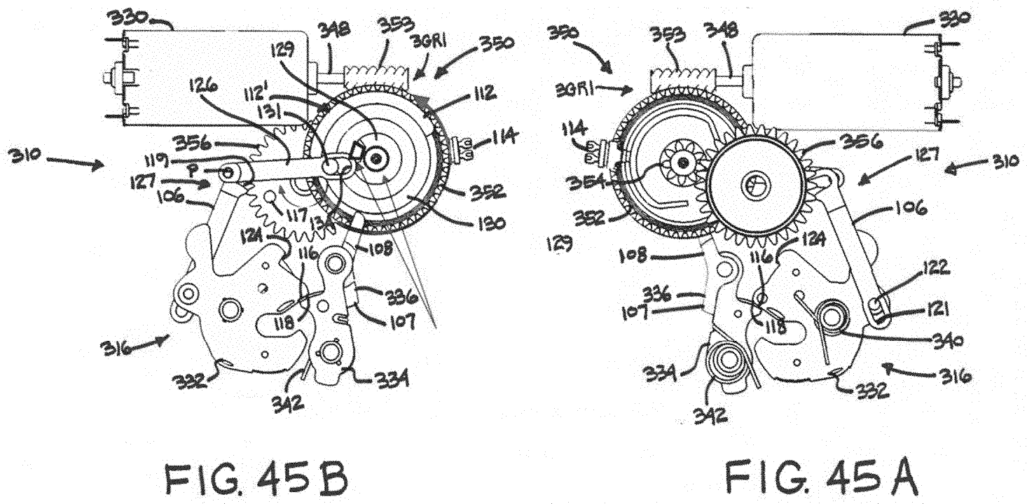

Central hub assembly 128 includes a central lever 129 (FIGS. 23A, 23B, 24A, and 24B) with biasing member, shown as a spring 129′, and a crash unlock lever 130 coupled with one another for selective conjoint movement as first driven gear 352 is driven in the clockwise direction (FIGS. 42B and 43B) and for selective lost-motion movement therebetween as first driven gear 352 is driven back in the counterclockwise direction with central lever 129 while crash unlock lever 130 remains stationary (FIGS. 45B and 46B).

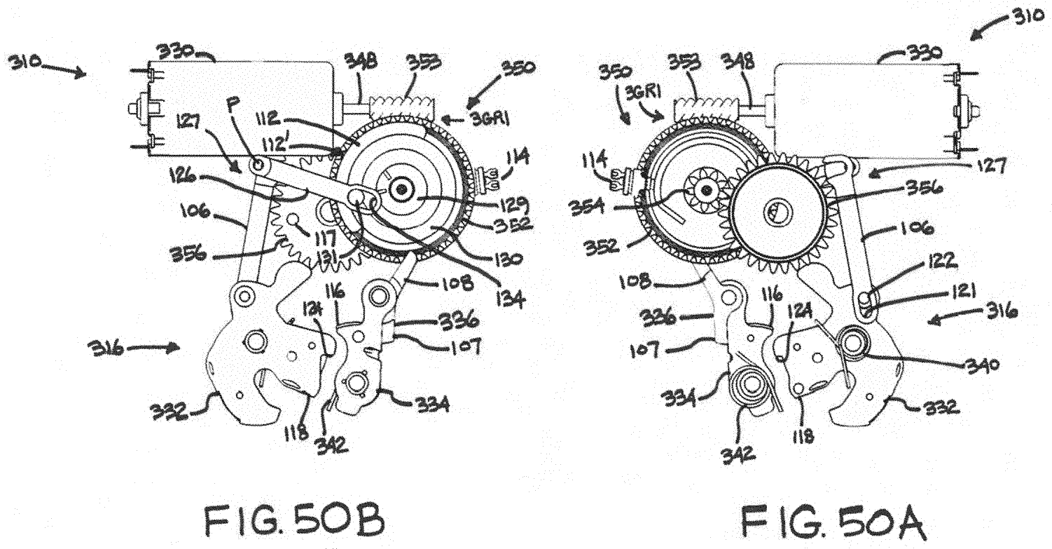

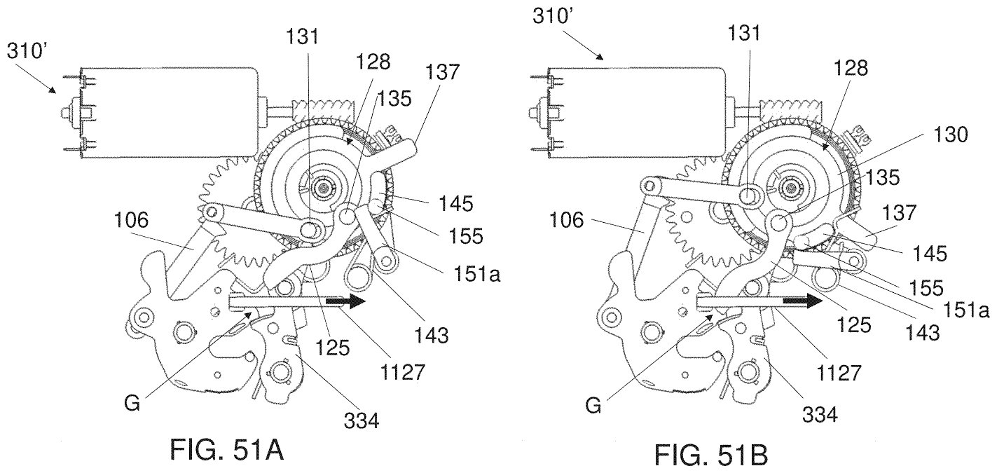

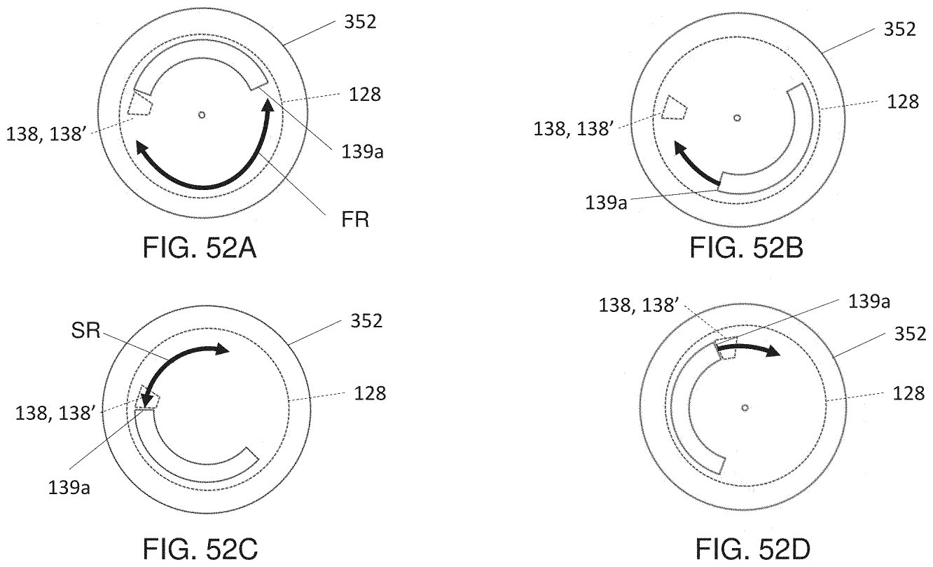

When first driven gear 352 is driven clockwise, a lug or lugs 138 (FIG. 24B) of central lever 129 interface with shoulder(s) 139 of a drive notch or slot 140 (FIG. 23A) in first driven gear 352 acting as a power take off output of first driven gear 352, thereby causing central lever 129 to be driven conjointly with first driven gear 352. However, it is to be understood that a lost-motion is present between lugs 138 and slot 140 when first driven gear 352 is driven counterclockwise in normal use. While first driven gear 352 is rotated over an angular range which does not cause lugs 138 to interact with shoulder 139 during a first range of motion FR (see FIG. 52A, 52B). , the secondary latch functions may not be actuated as central hub assembly 128 remains unsynchronized with the motion of the first driven gear 352. It is recognized that lugs 138 may contact shoulder 139 at the end of first angular range of motion of first driven gear 352 without causing or without causing any significant actuation of the secondary latch function(s). For example the first range of motion illustratively occurs between opposite stop positions as shown in FIG. 40B and FIG. 34B where at lug 138 may freely travel within slot 140. Accordingly, two separate extended functions may be provided depending on the direction the motor 330 is driven to move the first driven gear 352 beyond the two opposite ends of the first range of motion. For example, rotation of motor 330 in the clockwise direction may drive central hub assembly 128 in a clockwise direction when the gear 352 via a first shoulder 139a for example enters into contact with lug 138, 138′ (FIG. 52C) for activating an extended function of the latch (see FIG. 52D). Similarly, rotation of motor 330 in the counterclockwise direction may drive central hub assembly 128 in a clockwise direction when gear 352 via a second shoulder 139b for example enters into contact with lug 138 for activating another extended function of the latch. As a result, multiple extended latch functions may be provided as controlled by the multistage reduction mechanism moving a latch mechanism of as controlled by the central hub assembly moving a latch mechanism. As central lever 129 is driven clockwise, teeth 141 extending outwardly from an opposite side of central hub 129 from lugs 138 interface with and drive teeth 142 (FIG. 25B) fixed to crash unlock lever 130, thereby causing crash unlock lever 130 to rotate clockwise in conjoint relation with central lever 129 and first driven gear 352. As crash unlock lever 130 rotates clockwise when first driven gear 352 is driven in the clockwise direction, a drive lug 131 fixed to and extending outwardly from crash unlock lever 130 forcibly drives cinch disengage link 126 along the direction of arrow 132, which in turn drives cinch/ice break link 106 out from coupled relation with pin 117, as discussed above. Drive lug 131 is disposed with a slot 134 of cinch disengage link 126 for selective lost-motion travel therein, but while first driven gear 352 is driven in the clockwise direction, drive lug 131 is engaged with an end of slot 134, thereby causing cinch disengage link 126 to be driven along the direction of arrow 132, whereupon cinch disengage link 126 becomes uncoupled from pin 117 (FIGS. 43B to 44B). Central hub 128 functions as a control member driven by power received from the first driven gear 352 via a power take off output of first driven gear 352 illustratively described hereinabove with reference to a lost motion interface 149 or connection provided by lug 138 and shoulder(s) 139. As a result, the central hub 128, which may be provided as a control disc assembly illustratively provided in overlap with first driven gear 352 and/or nested with first driven gear 352, may thus receive lower torque and higher speed activation from the power take off output of first driven gear 352 for controlling one or more secondary functions of the power latch assembly, as compared to a power take off provided downstream the first driven gear 352 (such as pin 117 fixed to second driven gear 356) having slower speed and higher torque. In another possible configuration, control disc assembly may be illustratively controlled by second driven gear 356, for example provided in overlap with second driven gear 356 and/or nested with second driven gear 356 in a similar manner, may thus receive higher torque and slower speed activation from the power take off output of second driven gear 356 for controlling one or more latch functions of the power latch assembly e.g. primary or secondary function depending on the desired activation requiring a higher input torque. For example, control disc associated with the second driven gear 356 may drive a linkage for extending a retracted plunger for a high torque presenting function as one possible example of a latch function. As another example, control disc associated with the second driven gear 356 may drive a linkage for acting on the pawl 334 for a high torque latch release function. Control disc may be configured to activate more than one latch function. Power is transferred from the first driven gear 352 when lug 138 and shoulder(s) 139 are engaged and their motion is synchronized with each other which may occur when the first driven gear 352 is driven over a second range of motion beyond the first range of motion. For example second range of motion is illustratively shown in FIG. 42B moving further in a clockwise direction. Central hub 128 is provided having free motion relative to the first driven gear 352 and is held in place by the spring 129′ during normal function of the first driven gear 352, for example during the power release function, such that the central hub 128 may not move relative to the first driven gear 352, and central hub 128 may move when first driven gear 352 is driven beyond the home position. The activation of the central hub 128 over the second range of motion different than the first range of motion facilitates the motor 330 via the multistage reduction mechanism to separately control the extended latch functions without activating the primary latch functions. For example the lock status of the latch may be change (e.g. crash unlock function) by the motor 300 activation without causing a power release function. Independent control of the primary latch functions and the extended latch functions may be provided using only a single motor 330. Illustratively, central hub 128 may be configured to control multiple latch functions in addition to controlling the cinch disengage function, with now further reference to FIG. 51A to 51B showing control of an unlocking function by the central hub 128 of power latch assembly 310′ whereby a manual release mechanism may be coupled to or decoupled from the pawl 334 via activation of the central hub 128. Unlocking function may be realized in conjunction with the crash unlock function whereby the two functions may be activated e.g. the cinch disengage link 126 is uncoupled from pin 117 and a coupling link 125 is moved from an uncoupled position (see FIG. 51A) to a coupled position (see FIG. 51B) between a manual release lever 1127 forming part of the manual release mechanism and the pawl 334. As shown in FIG. 51B the coupling link 125 is moved by the central hub 128 into a gap G between the manual release lever 1127 and the pawl 334 such that the manual release lever 1127 may be able to urge the coupling link 125 against the pawl 334 when manual release lever 1127 is moved to cause release of the latch assembly. When the coupling link 125 is in the uncoupled position, the manual release lever 1127 may be moved within the gap towards the pawl 334 yet be unable to cause a movement of the pawl 334 to thereby provide a lock function of the latch assembly. Coupling link 125 is shown connected to the central hub 128 via a drive lug 135 extending from central hub 128 (for example extending from crash unlock lever 130) which is received in an aperture/slot provided on the coupling link 125. Lug 138′ shown in phantom outline illustrates another possible configuration of the lug 138′ extending from the body of the central lever 129 located within the inner periphery of the central lever 129. Providing the multistage reduction mechanism having continuously coupled gears, such as provided without any clutch mechanism, allows for the simultaneous activation of two latch functions, for example one controlled by an upstream gear e.g. first driven gear 352 having higher speed and another controlled by a downstream gear e.g. second driven gear 356 having high torque the lost motion interface. For example, first driven gear 352 may cause to activate the power release function before or as the ice/break function activates due to the speed reduction between the first upstream gear 352 and the second downstream gear 356.

Still referring to FIGS. 51A and 51B, central hub 128 may be driven manually using for example a driven extension 137 which may be coupled to an external interface for activation, which may be activated for example when power to the motor 330 is unavailable to rotate crash unlock lever 130, or during servicing of the power latch assembly. Driven extension 137 may be accessible from outside the latch, for example via a service access port (not shown) provided in the latch housing.

Upon cinch disengage link 126 being uncoupled from pin 117, as shown in FIGS. 45B to 46B, first driven gear 352 and central lever 129 are conjointly back-driven under a bias force of a spring load, while crash unlock lever 130 remains stationary under a bias of a detent spring 143 (see FIG. 51A, 51B) to couple a manual release mechanism to pawl 334. Detent spring 143 is shown to apply a detent holding force on central hub 128 illustratively on a control cam 145 extending from crash unlock lever 130 as shown in FIG. 51B. In order to overcome the detent holding force applied on the crash unlock lever 130, a reset lever assembly 151a is provided to act on crash unlock lever 130 via an applied force to control cam 145 (e.g. on a projection 155). The reset lever assembly 151a may be moved by the first driven gear 352 rotation, and by a counterclockwise rotation of first driven gear 352 rotation starting from the position in FIG. 51B. First driven gear 352 comprises a control cam surface provided on the opposite face of first driven gear 352 viewed in FIG. 27A for example which engages a driven reset lever assembly 151b connected to the reset lever assembly 151a. As the first driven gear 352 is rotated, the reset lever assembly 151a can urge the crash unlock lever 130 in the counterclockwise direction until the holding force of detent spring 143 is overcome and detent spring 143 disengages from control cam 145.

Now referring back to FIGS. 45B to 46B, the lost-motion between central lever 129 and crash unlock lever 130 is permitted via spacing between their respective teeth 141, 142. Then, as shown in FIGS. 48B-50B, the manual release mechanism is actuated, such as for example by an inside and/or outside door handle, to move pawl 334 against the bias of pawl biasing member 342 to the ratchet releasing position, whereat ratchet 332 is moved to the striker release position under the bias of ratchet biasing member 340.

In accordance with a further aspect of the disclosure, a method of releasing a power latch assembly and presenting a closure panel of a motor vehicle is provided. The method comprising: operating a motor of the power latch assembly in a first mode to rotate an output in a first direction to move a pawl from a ratchet holding position to a ratchet releasing position and causing a ratchet to move from a striker capture position to a striker release position until the power latch assembly is released; and operating the motor of the power latch assembly in a second mode to drive a presenter from a retracted state to an extended state to move the closure panel to at least a partially open position.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A power latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a power actuator having an output; and
a multistage mechanism operably connected to the output of the power actuator, the multistage mechanism configured to actuate a primary latch function during a normal operating mode and actuate a secondary latch function during an extended operating mode.

2. The power latch assembly of claim 1, wherein during the normal operating mode the multistage mechanism is driven over a first range of motion, and wherein during the extended operating mode the multistage mechanism is driven over a second range of motion.

3. The power latch assembly of claim 1, wherein the multistage mechanism is configured to actuate a control member, the control member configured for actuating the secondary latch function.

4. The power latch assembly of claim 3, wherein the multistage mechanism comprises a geartrain, wherein the control member is configured to be actuated by one of the gears of the geartain.

5. The power latch assembly of claim 4, wherein a lost motion interface is provided between the control member and one of the gears.

6. The power latch assembly of claim 3, wherein the primary latch function includes one of a power release function, a cinch function, and an icebreak/present function, and wherein the secondary latch function includes one of an unlock function, a cinch disengage function, and a double pull function.

7. The power latch assembly of claim 1, wherein the multistage mechanism is operated in the extended operating mode during an emergency condition of the power latch assembly.

8. A power latch assembly for a closure panel, comprising:
a ratchet configured for movement between a striker capture position and a striker release position and being biased toward said striker release position;
a pawl configured for movement between a ratchet holding position, whereat said pawl maintains said ratchet in said striker capture position, and a ratchet releasing position, whereat said pawl releases said ratchet for movement of said ratchet to said striker release position;
a power actuator configured to move said pawl from the ratchet holding position to the ratchet releasing position; and
a multistage mechanism operably connecting an output of the power actuator to at least one of the pawl and the ratchet, the multistage mechanism having at least two power takeoffs, with each power takeoff being configured to apply a different torque output to at least one of the pawl and/or the ratchet.

9. The power latch assembly of claim 8, wherein the power actuator is configured to rotate a first driven member from a home position in a first direction to apply a first torque to the pawl to cause the pawl to move from the ratchet holding position to the ratchet releasing position and to apply a second torque to the ratchet after applying the first torque to the pawl, wherein the second torque is greater than the first torque.

10. The power latch assembly of claim 9, wherein the first torque is generated by a first gear train and the second torque is generated by a second gear train.

11. The power latch assembly of claim 10, wherein the first gear train is provided by a drive gear couple to an output of the power release actuator and the first driven gear, wherein the drive gear is configured to drive the first driven gear in the first direction to generate the first torque, and the second gear train is provided by a pinion gear fixed to the first driven member and a second driven gear, wherein the pinion gear is configured to drive second driven gear as the first driven gear rotates in the first direction.

12. The power latch assembly of claim 11, wherein the drive gear is in meshed engagement with the first driven gear and the pinion gear is in meshed engagement with the second driven gear.

13. The power latch assembly of claim 11, further including a first link coupling the second driven gear to the ratchet.

14. The power latch assembly of claim 13, wherein the first link is detachably coupled to the second driven gear.

15. The power latch assembly of claim 14, further including a second link operably coupling the first driven gear to the first link.

16. The power latch assembly of claim 15, further including a central hub assembly coupled to the first driven gear for lost-motion with the first driven gear, with the second link being coupled to the central hub assembly.

17. The power latch assembly of claim 16, wherein the central hub assembly is configured to remain substantially stationary when the first driven member rotates in the first direction.

18. The power latch assembly of claim 17, wherein the central hub assembly includes a central lever coupled to a crash unlock lever, wherein the central lever and the crash unlock lever are configured for lost-motion with one another.

19. The power latch assembly of claim 18, wherein with the second link is coupled to the crash unlock lever.

20. The power latch assembly of claim 8, further including a central hub assembly coupled to the multistage mechanism, wherein the central hub is adapted to control extended latch functions separately from the multistage mechanism controlling the pawl and/or the ratchet.

21. A method of operating a power latch assembly of a closure panel of a motor vehicle, comprising:
operating a motor of the power latch assembly in a normal mode to actuate a multistage mechanism to control a primary latch function; and
operating the motor of the power latch assembly in an extended mode to actuate a multistage mechanism to control a secondary latch function.
